(19) United States
(12) Patent Application Publication
(10) Pub. No.: US 2025/0197057 A1
(43) Pub. Date: Jun. 19, 2025

(54) WORK PLATFORM FOR STACKABLE STORAGE SYSTEM

(71) Applicant: The Stanley Works Israel Ltd., Rosh Ha'Ayin (IL)

(72) Inventors: Adar Omry, Hertzeliya (IL); Ohad Waissengreen, Emek Sorek (IL); Doron Livne, Ruchama (IL)

(73) Assignee: The Stanley Works Israel Ltd., Rosh Ha'Ayin (IL)

(21) Appl. No.: 18/913,655

(22) Filed: Oct. 11, 2024

Related U.S. Application Data
(60) Provisional application No. 63/609,582, filed on Dec. 13, 2023.

(51) Int. Cl. B65D 19/00; B25H 3/02; B65D 19/38; B65D 21/02; B65D 25/20

(52) U.S. Cl. CPC B65D 19/0002; B25H 3/028; B65D 19/38; B65D 21/0209; B65D 25/20; B65D 2255/00

(57) ABSTRACT

A work platform for a drawer storage module is disclosed. The module includes one or more slidable drawers and a locking bar having a locking opening and which may be pivoted between a vertical position covering the drawers and securing them within the module and a horizontal position clear of the drawers so that they can be opened. The work platform has a work surface and a peripheral rim extending downwardly from the work surface. A through hole is formed on the peripheral rim. The work platform may be disposed on an upper surface of the module with the locking opening adjacent the through hole. The work platform may also be disposed on storage containers forming part of a stackable system including quarter-sized containers, half-sized containers and full-sized containers in alternative combinations thereof.

### CROSS REFERENCE TO RELATED APPLICATIONS

This application claims the benefit of U.S. Provisional Application No. 63/609,582 filed on Dec. 13, 2023. The entire disclosure of the above application is incorporated herein by reference.

### FIELD OF THE INVENTION

The present invention relates to a work platform for use with a stackable storage system which includes a plurality of storage containers of different sizes which may be secured to each other, for example, for joint movement by a dolly or wheeled cart.

### BACKGROUND

Stackable storage containers are known, for example, the rolling container assembly shown in U.S. Pat. Nos. 8,132,819 and 9,132,543, which are hereby incorporated by reference. The assembly disclosed therein includes a base storage container which is disposable on a cart which is provided with wheels and an integral handle system. At least one further storage container may be removably attached on top of the base container, allowing for multiple containers to be jointly transported. The mechanism for attaching the containers to each other in such systems may include a stacking latch mechanism, for example, as shown in U.S. Patent Application Publication Nos. 2020/0025229 and 2020/0298392 and U.S. Pat. No. 11,486,427, which are hereby incorporated by reference. The mechanism includes a spring loaded pivotable latch having a hook disposed on the lid of the container and a step formed on the lower housing of the container. The latch hook is selectively disposable over the step to thereby secure the containers together. U.S. Pat. No. 8,505,729 discloses a stackable container system in which each container includes a latch member and a ledge formed on the outer surface. The latch of a lower container is foldable over the ledge of an upper container to secure the upper and lower containers together.

With further reference to Prior Art FIG. 13, components of a known stackable system are shown. Container 90 includes base 95 having an interior storage volume and cover 96 pivotably attached to base 95. Base 95 includes step 93 extending downwardly from a lower side edge thereof. Though not shown, a second step having the same structure extends downwardly from the opposite lower side edge. Spring biased latch 92 extends upwardly from the upper side edge of cover 96. Though not shown a second spring biased latch having the same structure would extend upwardly from the opposite side edge of cover 96. T-Tab 91 extends upwardly from a central region of cover 96 and has two overhanging ledges. T-Tab may be raised or lowered from the upper surface of cover 96. Conventional accessory box 94 includes base 98 and pivotable cover 97 disposed thereon. Step 93′ having the same structure as step 93 extends downwardly from a lower long side edge thereof. Though not shown a second step having the same structure would extend from the opposite long side edge thereof. Spring biased latch 92′ having the same structure as spring biased latch 92 extends upwardly from the front side edge of cover 97. To secure accessory box 94 onto container 90, step 93′ is inserted beneath a ledge of raised T-Tab 91, and the opposite side step is secured beneath the second spring biased latch of container 90. The not shown second step 93′ contacts the hook of the not shown second latch 92 to rotate latch 92 outwardly until step 93′ clears the hook to allow latch 92 to rotate back inwardly under the spring bias such that the hook overlies step 93′. Alternatively, T-Tab 91 could be lowered and a container having substantially the same overall lower surface area as the upper surface of cover 96 of container 90 could be secured between spring biased latch 92 and the not shown second latch 92. A further container could be secured on cover 97 between spring biased latches 92′. The structure of latches 92,92′ and steps 93,93′ could, for example, have the structure as shown in the above-referenced published patent applications and patents.

With reference to Prior Art FIG. 14, a further known stackable storage system is disclosed. The stackable storage system includes a plurality of stackable storage containers 60(a), 60(b) and 60(c), of substantially the same surface area but having varying depth, each of which includes a cover having latch mechanisms 92 disposed thereon. Containers 60(b) and 60(c) each have steps 93. Chest 60(a) is the lowest container of the stack and may be integrally formed with wheels and an upright pull handle to allow the stackable storage system to be transported by tilting and rolling. Upper container 60(c) has the same structure as container 90 described above. The incorporation of latches 92, steps 93, and T-Tab 91 allows containers of various depths and surface areas to be incorporated into and secured in the stackable storage system.

### SUMMARY OF THE INVENTION

In a first embodiment the invention is directed to a work platform having a work surface and a peripheral rim extending downwardly from the work surface. At least one step is formed on the peripheral rim. At least one through hole is formed on the peripheral rim. The work platform may be disposed on an upper surface of a storage container having a locking opening and at least one latch disposable over the at least one step to secure the platform on the container with the locking opening adjacent the at least one through hole.

In a further embodiment the invention is directed a system including a storage container and a work platform. The storage container includes at least one latch and at least one locking opening. The work platform includes a work surface, a peripheral rim extending downwardly from the work surface, and at least one step formed on the peripheral rim, and at least one through hole formed on peripheral rim. The work platform may be disposed on an upper surface of the storage container with the at least one latch disposable over the at least one step to secure the platform on the container with the at least one locking opening adjacent the at least one through hole.

In a further embodiment the invention is directed to a system having a storage container and a work platform. The storage container has an upper surface, a first latch disposed on one side of the upper surface, and a second latch disposed on an opposite side of the upper surface. The work platform has a work surface and a peripheral rim extending downwardly from the work surface on at least first and second opposite sides thereof. A first step is formed on the first opposite side and a second step is formed on the second opposite side. The work platform may be disposed on the upper surface of the storage container with the first latch disposable over the first step and the second latch disposable over the second step to secure the work platform on the storage container.

In a further embodiment the invention is directed to a system having a work platform having a work surface. Two front steps extending downwardly from the work surface at a front side thereof and two rear side steps extending downwardly from said work surface at a rear side thereof. The system includes at least two first storage containers each having a first storage container upper surface and a first storage container latch extending upwardly from a first side of said first storage container upper surface. The system includes at least one second storage container having a second storage container upper surface and a second storage container first latch and a second storage container second latch extending upwardly from opposite sides of the second storage container upper surface. The work platform may be disposed simultaneously on all of the upper surface of the second storage container and the upper surfaces of the at least two first storage containers, with the latch of one first storage container disposed over one of the front side steps, with the latch of another of the first storage containers disposed over one of the rear side steps, with the second container first latch disposed over another of the front side steps and the second container second latch disposed over another of the rear side steps.

In a further embodiment the invention is directed to a system further having at four first storage containers. The work platform alternatively may be disposed simultaneously on an upper surface of each of the four first storage containers, with the latch of one first storage container disposed over one of the front side steps, with the latch of another first storage container disposed over one of the rear side steps, with the latch of a third first storage container disposed over another of the front side steps and said with the latch of a fourth first storage container disposed over another of said rear side steps

In a further embodiment the invention is directed to a system having a work platform having a work surface. The system further includes a first storage container having an upper surface defining a first area and a second storage container having an upper surface defining a second area. The work platform may be disposed and secured on a combination of four first storage containers, and the work platform alternatively may be secured and disposed on and secured on a combination of two of the first storage containers and one of the second storage containers, and the work platform alternatively may be secured and disposed on a combination of two of the second storage containers.

In a further embodiment the invention is directed to a system having a work platform having a work surface. The system further includes a first storage container having an upper surface defining a first area and a second storage container having an upper surface defining a second area. The work platform may be disposed and secured on a combination of four first storage containers, and the work platform alternatively may be secured and disposed on and secured to the second storage container.

In a further embodiment the invention is directed to a system having a work platform having a work surface. The system further includes first storage container having an upper surface defining a first area and a second storage container having an upper surface defining a second area. The work platform may be disposed and secured on a combination of two first storage containers, and the work platform alternatively may be secured and disposed on and secured to the second storage container.

These and other objects, features, and characteristics of the present invention, as well as the methods of operation and functions of the related elements of structure and the combination of parts will become more apparent upon consideration of the following description and the appended claims with reference to the accompanying drawings, all of which form a part of this specification, wherein like reference numerals designate corresponding parts in the various figures. It is to be expressly understood, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural references unless the context clearly dictates otherwise.

### BRIEF DESCRIPTION OF THE DRAWINGS

FIG. 1 is a left front side perspective view of a stackable storage drawer according to the invention.

FIG. 2 is an overhead right side perspective view of the stackable storage drawer shown in FIG. 1.

FIG. 3 is an underside back right side perspective view of the stackable storage drawer shown in FIG. 1.

FIG. 4 is a perspective view of a sliding tab forming part of the stackable storage drawer shown in FIG. 1.

FIG. 5 is a closeup overhead view of a portion of the upper surface of the stackable storage drawer shown in FIG. 1.

FIG. 6 is a perspective view of a locking tab forming part of the stackable storage drawer shown in FIG. 1.

FIG. 7 is a vertical cross section view taken laterally across the stackable storage drawer shown in FIG. 1 and parallel to the front surface.

FIGS. 8A-8L are perspective views of the stackable storage drawer shown in FIG. 1 incorporated into a stackable container system with various containers or other stackable storage drawers disposed thereon in different configurations.

FIGS. 9A-9F are overhead views showing different orientations in which various containers may be secured on the stackable storage drawer shown in FIG. 1.

FIG. 10A is a perspective view showing one container disposed on the stackable storage drawer shown in FIG. 1.

FIG. 10B is a cross-sectional view showing two containers secured in a front to back relationship on the stackable storage drawer shown in FIG. 1.

FIG. 11 is perspective view showing a sliding tab forming part of the stackable storage drawer according to a second embodiment.

FIG. 12 is perspective view showing a rotating tab forming part of the stackable storage drawer according to a third embodiment.

FIG. 13 is a perspective view of a prior art stackable storage system incorporating a T-tab on the cover thereof.

FIG. 14 is a perspective view of a prior art stackable storage system incorporating a wheeled lower storage container.

FIG. 15 is a right rear side perspective view of a stackable storage container according to a further embodiment of the invention.

FIG. 16 is a right front side perspective view of the stackable storage container shown in FIG. 15.

FIG. 17 is a top view of the stackable storage container shown in FIG. 15.

FIG. 18 is a left front side perspective view of a stackable storage drawer module showing the lock bar according to the invention in detail.

FIG. 18A is left front side perspective view of a stackable storage drawer module showing the lock bar according to a second embodiment of the invention in detail.

FIG. 18B is left front side perspective view of the stackable storage drawer module shown in FIG. 18A with the lock bar and padlock not shown.

FIG. 19 is front elevational view of the stackable storage drawer module as shown in FIG. 18.

FIG. 20 is an overhead view of the stackable storage drawer module as shown in FIG. 18.

FIG. 21 is a front elevational view of the lock bar as shown in FIGS. 18 and 19.

FIG. 22 is a front perspective view of the lock bar shown in FIG. 21.

FIG. 23 is rear elevational view of the lock bar shown in FIG. 21.

FIG. 24 is a closeup overhead view showing a portion of the upper surface of the stackable storage drawer module shown in FIG. 18.

FIG. 25 is a front elevational view showing two stackable storage drawer modules as shown in FIG. 18, with one storage drawer module stacked on the other storage drawer module.

FIG. 26A is a front elevational showing two stackable storage drawer modules as shown in FIGS. 18A-B secured together with a padlock.

FIG. 26B is a right side perspective view of the two stackable storage drawer modules shown in FIG. 26A.

FIG. 26C is a close up view of the two stackable storage drawer modules shown in FIG. 26B with certain components removed.

FIG. 27 is a front elevational view as in FIG. 19 with various positions of the lock bar shown.

FIG. 28 is a close up front view showing a portion of the top of a stackable storage drawer module as shown in FIG. 18.

FIG. 29 is a close up front view showing a portion of two stacked stackable storage drawer modules as shown in FIG. 25.

FIG. 30 in a close-up right side perspective view showing a portion of the stackable storage drawer module shown in FIG. 18 with certain components removed.

FIG. 31 is a front perspective view of a work platform.

FIG. 32 is a front perspective view of a work platform according to FIG. 31 secured on the upper stackable storage drawer module shown in FIG. 26.

FIG. 33 is an underside perspective view of the work platform shown in FIG. 31.

FIG. 34 is a side view of the work platform shown in FIG. 31.

FIG. 35 a perspective view showing the work platform in FIG. 31 secured on two quarter-sized and one half-sized containers.

FIG. 36A is a perspective view of a quarter sized storage container.

FIG. 36B is a perspective view of half-sized storage container.

FIG. 37 is a perspective view showing the work platform of FIG. 31 secured on four quarter-sized containers.

FIG. 38 is a perspective view showing the work platform of FIG. 31 secured on two half-sized containers.

### DETAILED DESCRIPTION OF EXEMPLARY EMBODIMENTS

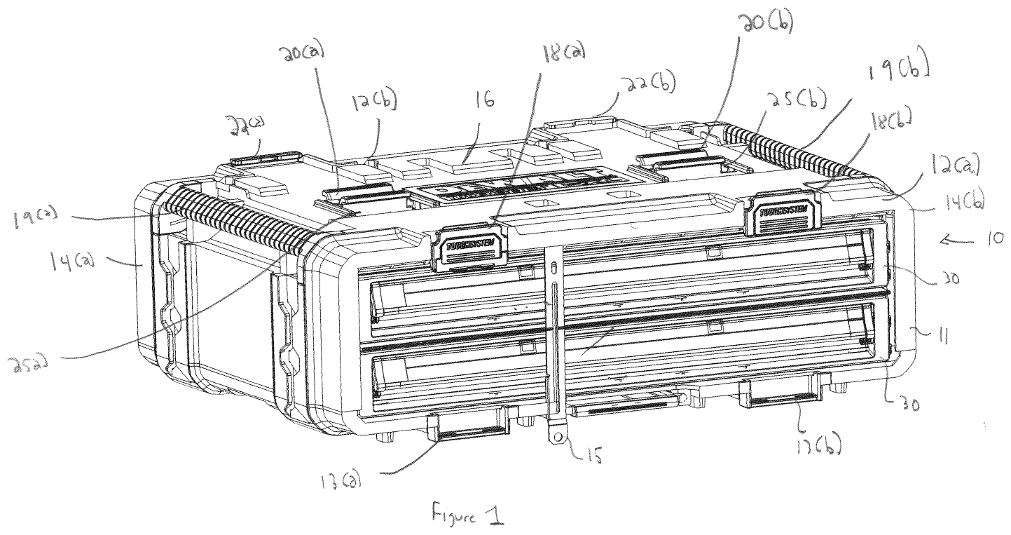

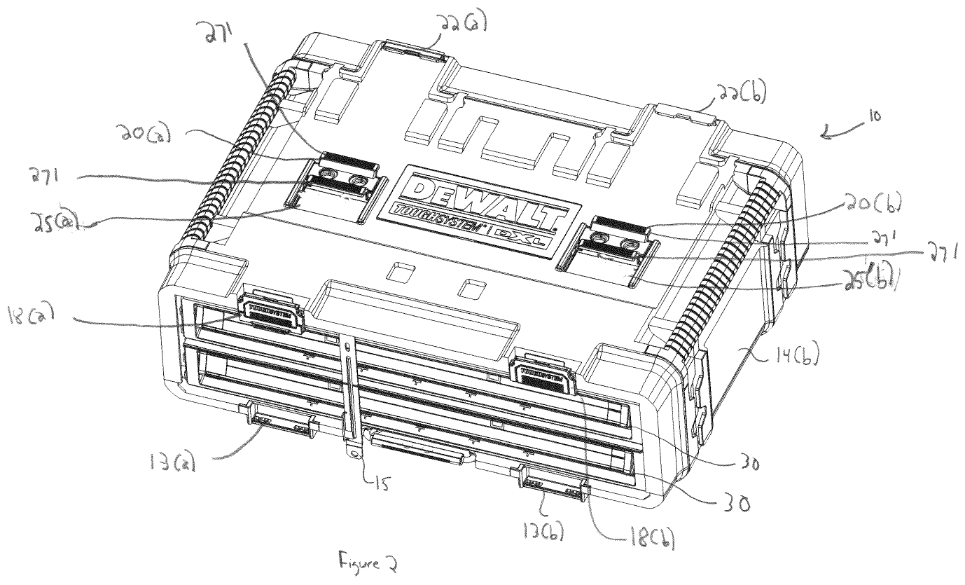

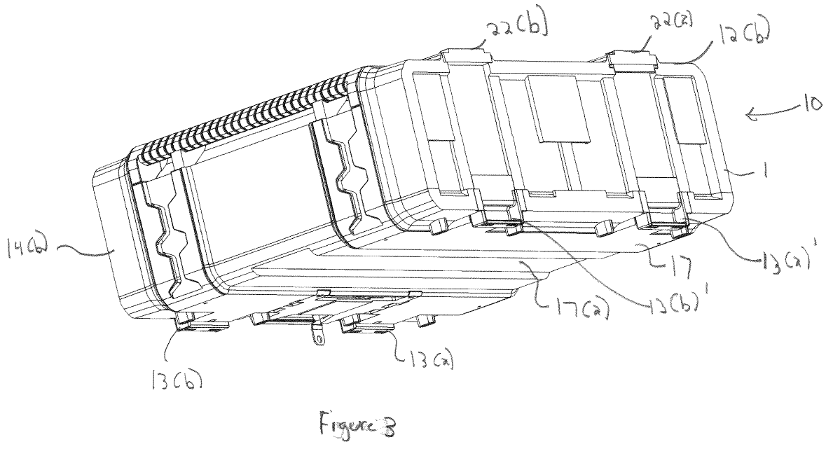

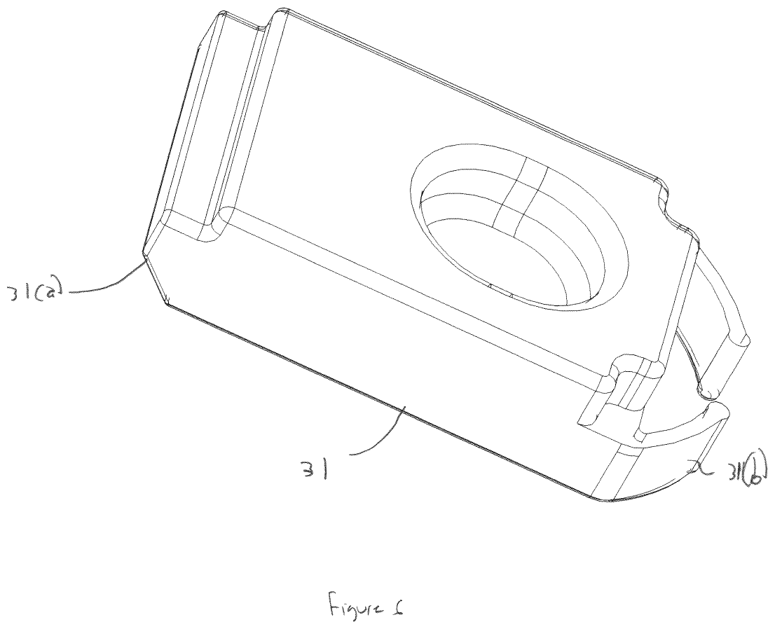

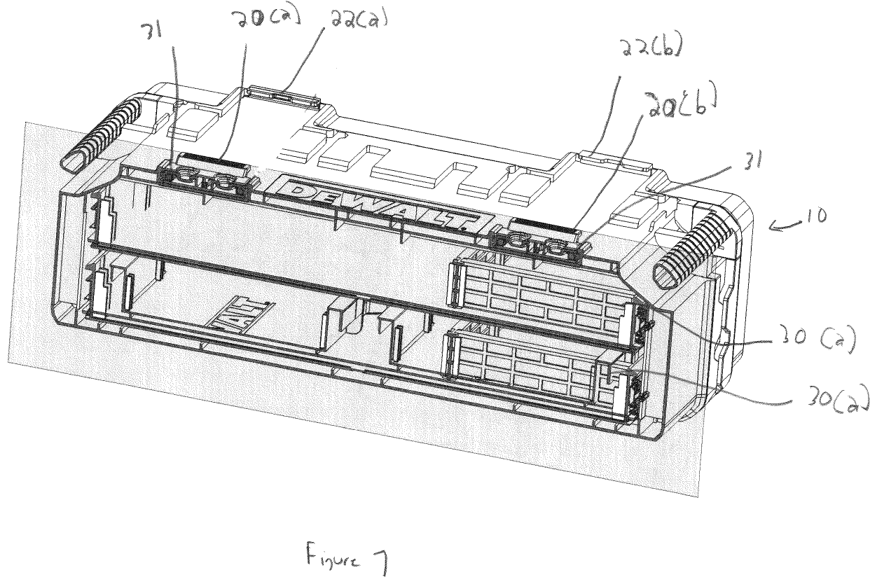

With reference to FIGS. 1-3, drawer storage module 10 includes drawer storage housing 11 having upper surface 16 extending between front long side 12(a), rear long side 12(b), left short side 14(a) and right short side 14(b). Front long side 12(a) is parallel to rear long side 12(b) and left short side 14(a) is parallel to right short side 14(b). The use of the terms front, rear, left, right, short and long are for the sake of description only and are not intended to limit the invention. Additionally, for the sake of convenience of description only, the direction extending between left short side 14(a) and right short side 14(b) shall be referred to as the longitudinal direction and the direction between front long side 12(a) and rear long side 12(b) shall be referred to as the lateral direction. Front long side 12(a) has an open face and one or more storage drawers 30 are slidably disposed therein which may be pulled out from front long side 12(a) to allow storage of tools or other items therein. Locking bar 15 may be rotated into or out of a position in front of storage drawers 30 to lock them in place in drawer storage housing 11. Left gripping handle 19(a) and right gripping handle 19(b) are integrally molded into drawer storage module 10. With reference to FIG. 7, drawers 30 may include separate compartments 30(a) formed therein.

Left spring loaded latch 18(a) and right spring storage latch 18(b) are disposed in channels formed on front long side 12(a) adjacent upper surface 16. Left latch 18(a) is disposed at a location between left short side 14(a) and a central vertical plane extending along the lateral direction and which bisects drawer storage module 10. Right latch 18(a) is symmetrically disposed between the central vertical plane and right short side 14(b), that is, on the opposite side of the central vertical plane from left latch 18(a). The structure and functioning of latches 18(a) and 18 (b) are substantially the same as the stacking latch mechanisms shown and described in the above-referenced U.S. Patent Application Publication Nos. 2020/0025229 and 2020/0298392, U.S. Pat. No. 11,486,427, and each include latch hooks extending inwardly relative to surface 16. Housing 11 includes front left step 13(a) and front right step 13(b) which extend downwardly from the lower edge of front long side 12(a) at a location below left latch 18(a) and right latch 18(b), respectively, and each also include a ledge. The structure of steps 13(a), 13(b) are similar to steps shown in the above-referenced applications and patent. The latch hooks of latches 18(a) and 18(b) may removably overlie steps 13(a) and 13(b), respectively, of a storage housing 11 of a second storage module 10 to removably secure one storage module 10 on top of the other on side thereof, in the same manner as the stackable containers shown in the incorporated applications and patent. Additionally, and as further described below, containers of various sizes and also having steps similar to steps 13(a) and 13(b) may be secured to module 10 on upper surface 16.

Left and right upper rear side tabs 22(a) and 22(b) are formed on rear long side 12(b) at locations generally opposite left and right spring loaded latches 18(a) and 18(b), respectively. Tabs 22(a) and 22(b) are integrally molded with housing 11 and each have an overhanging ledge which extends above and substantially parallel to upper surface 16 in a spaced relationship thereto. Housing 11 includes rear lower left step 13(a)′ and rear lower right step 13(b) which extend downwardly from the lower edge of rear long side 12(b) at a location below left upper rear side tab 22(a) and right upper rear side tab 22(b), respectively. The structure of steps 13(a)′ and 13(b)′ are similar to steps 13(a) and 13(b).

Left and right sliding surface tabs 20(a) and 20(b) are slidably disposed on upper surface 16 and generally extend along a central vertical plane which extends along the longitudinal direction and which approximately bisects drawer storage module 10. Left sliding surface tab 20(a) is disposed between left spring loaded latch 18(a) and left upper rear side tab 22(a) and right sliding surface tab 20(b) is disposed between right spring loaded latch 18(b) and right upper rear side tab 22(b). Left and right sliding surface tabs 20(a) and 20(b) are each slidably disposed in the lateral direction and within left side indentation 25(a) and right side indentation 25(b), respectively, which are each formed in upper surface 16. Left sliding surface tab 20(a), left upper rear side tab 22(a) and left latch 18(a) are disposed in a linear arrangement such that all three elements are intersected by a vertical plane extending in the lateral direction, with plane generally bisection the elements. The same arrangement is true of right sliding surface tab 20(b), right rear side tab 22(b) and right latch 18(b).

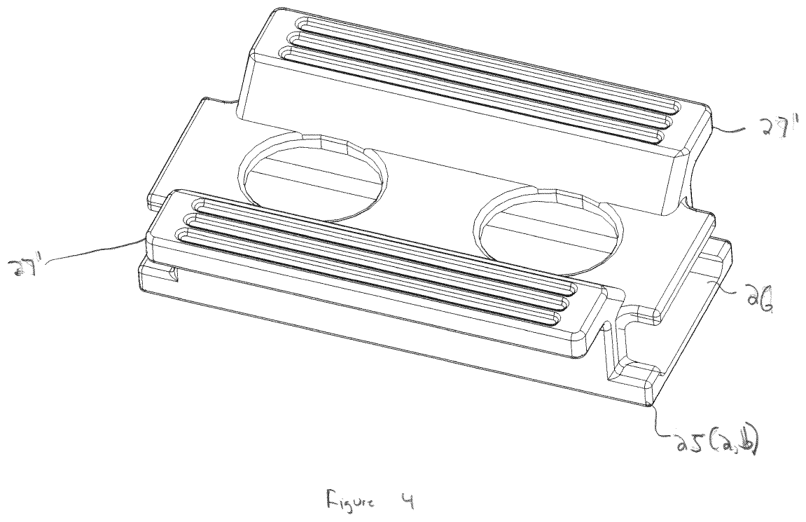

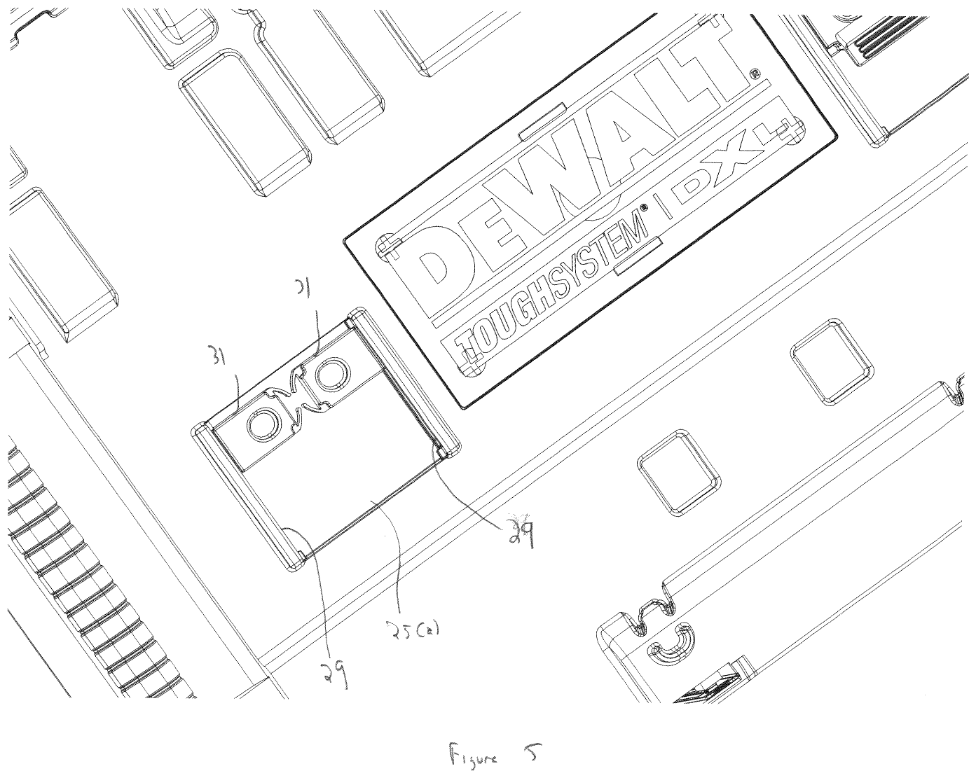

With further reference to FIGS. 4 and 5, each of sliding surface tabs 22(a) and 22(b) include a longitudinally extending body having upper and lower surfaces defining an interior volume which is open at left and right side openings 26. Front and rear overhanging hooks or ledges, each of which is numbered as 27′, which extend outwardly from the upper surface. Overhanging ledges 27′ extend in the longitudinal direction and are displaced from the surface of indentations 25(a) and 25(b). Indentations 25(a) and (b) each include left and right side channels 29 which are each formed below opposite side laterally extending overhanging walls formed in indentations 25(a) and 25(b). With reference to FIG. 6, locking tabs 31 each include a laterally outward protrusion 31(a) and hook springs 31(b) disposed oppositely of protrusions 31(a). Locking tabs 31 are force fitted into side openings 26 of sliding tabs 20(a) and (b), with hook springs 31(b) biased outwardly to secure tabs 22(a) and 22(b) on locking tabs 31. Protrusions 31(a) of each tabs 20(a) or 20(b) fit within and are secured under the left and rights side channels 29 to allows tabs 20(a) and 20(b) to be slid in the lateral direction in indentations 25(a) and 25(b). Tabs 20(a) and 20(b) may therefore be moved forwardly and rearwardly in indentations 25(a) and (b). The sliding movement of tabs 20(a) and 20(b) is thus in the lateral direction, generally perpendicular to front long side 12(a) and rear long side 12(b) and parallel to left short side 14(a) and right short side 14(b).

One drawer storage module 10 may be secured on the upper surface 16 of another drawer storage module 10 by inserting rear lower left step 13(a)′ and rear lower right step 13(b)′ of the upper storage module 10 beneath the corresponding upper left rear side tab 22(a) and upper right rear side tab 22(b) of the lower storage module. The upper storage module 10 would then be lowered fully onto the lower storage module 10 with left front lower step 13(a) and right front lower step 13(b) of the upper module 10 contacting and then sliding beneath the hooks of left spring loaded latch 18(a) and right spring loaded latch 18(b), in the same manner as described in the above-referenced patent applications and patent. The hooks of latches 18(a) and 18(b) overlie front lower left step 13(a) and front lower right step 12(b) to secure the front of the upper storage module 10 to the lower storage module 10.

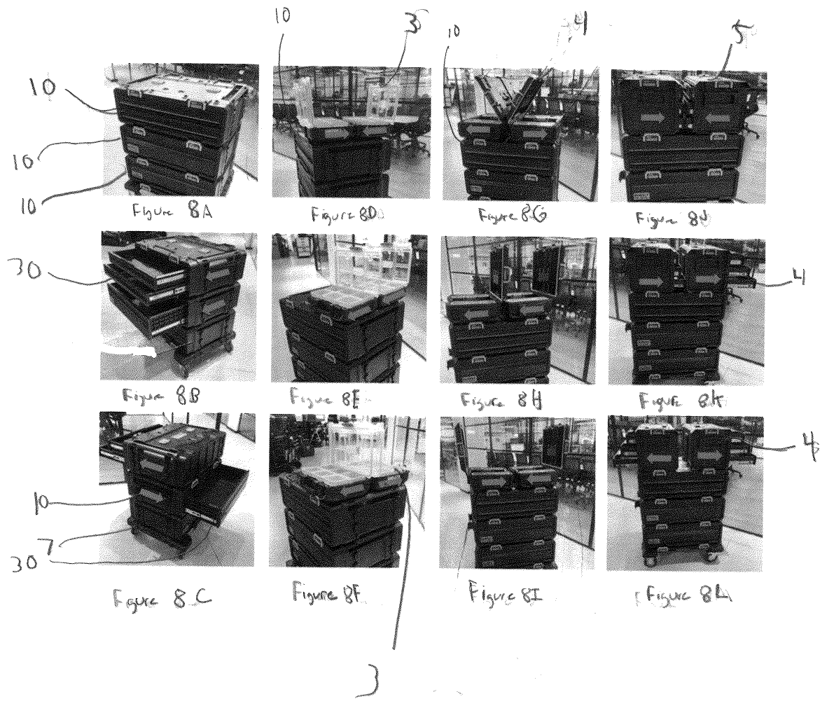

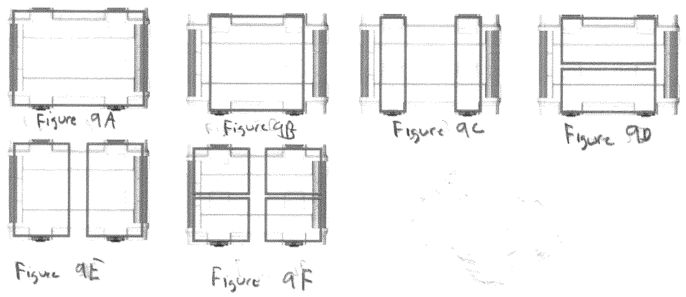

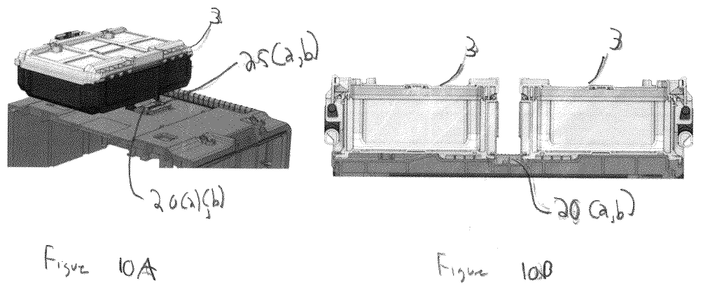

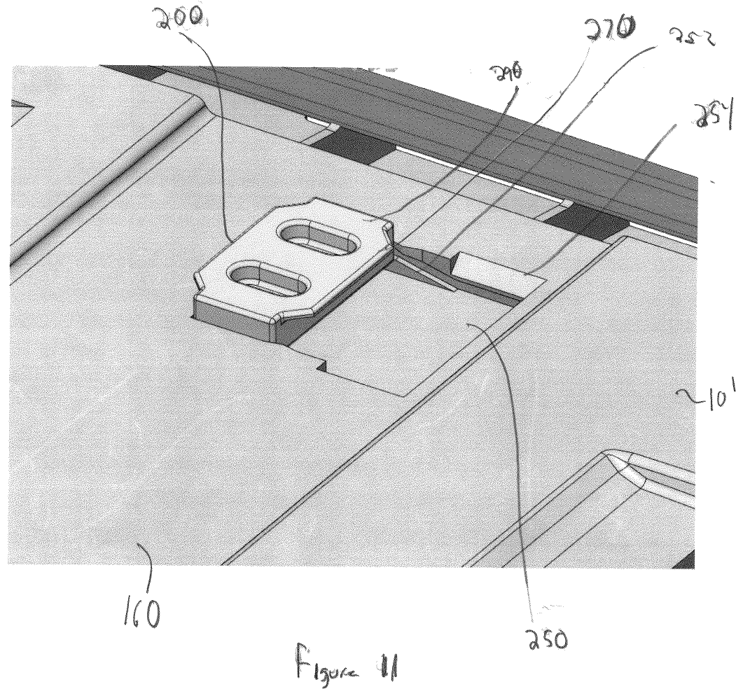

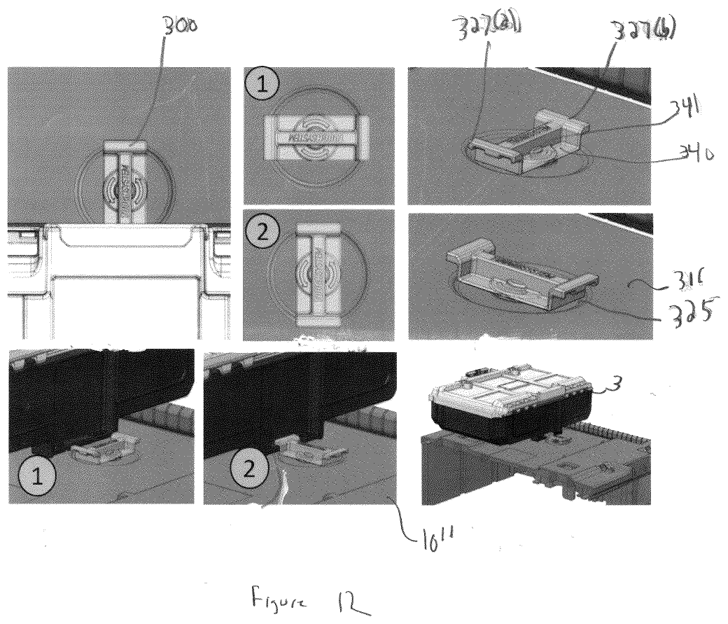

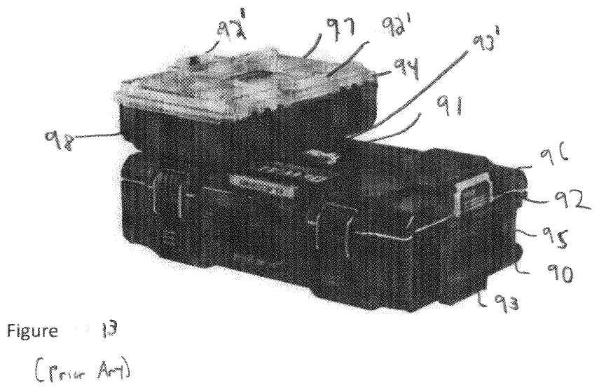

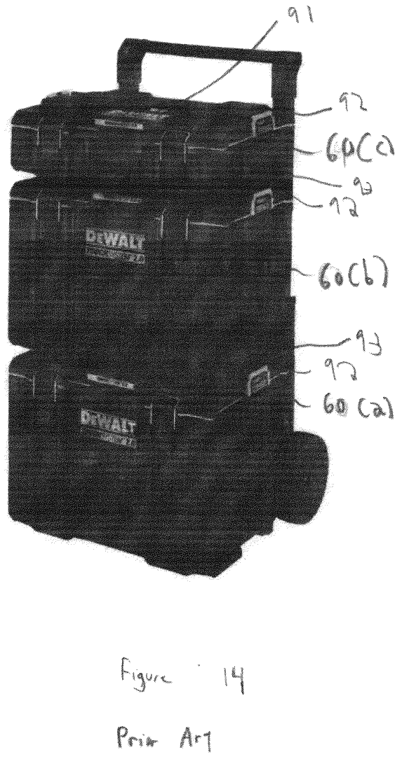

With reference to FIGS. 8A-8C, various configuration for stacking drawer storage module upon each other are shown. Three drawer storage modules 10 are shown, with the lower module 10 secured on dolly 7 which also includes latches having the same structure as spring loaded latches 18(a) and 18(b). The drawer storage modules 10 are stacked upon each other, with the lowest drawer storage module 10 stacked on dolly 7. In FIGS. 8A and 8B, front sides 12(a) of all of drawer storage modules 10 face the same direction such that slidable drawers 30 all open towards the same side. However, in FIG. 8C, the middle storage module 10 of the stack is orientated in the opposite direction so that the drawers 30 thereof open oppositely from the drawers 30 of the other two. Although the stacking of drawer storage modules 10 has been described, a full sized container having front and rear, left and right steps also could be stacked on top of a drawer storage module 10 in the same manner.

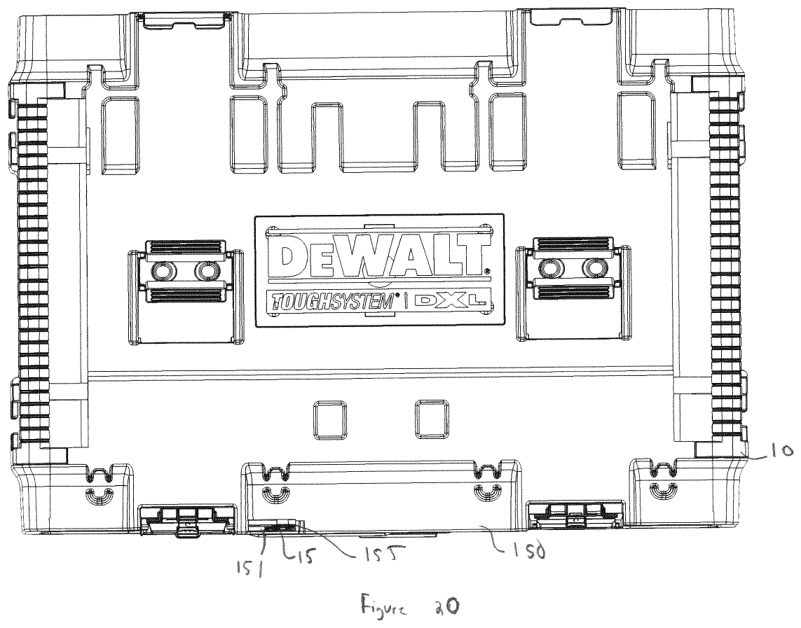

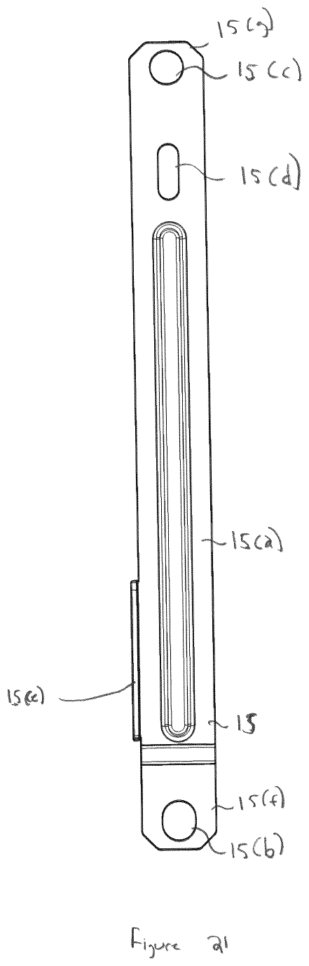

With reference to FIGS. 8D-8L, the various configurations in which containers of various sizes may be removably secured on upper surface 16 of storage module 10 is shown. The containers may be, for example, compartmentalized accessory box 3, similar in structure to accessory box 94 described with reference to FIG. 13, which includes a container base and lid, with the base having lower steps extending from opposite front and rear sides thereof, at a central location in the lateral direction. (For purposes of description front and rear are defined as the side from which the lid moves upwardly away, and the side which the lid is secured to and which serves as the pivot axis, respectively.) The lid is pivotably secured at one upper end of the container and may also have a latch similar to spring loaded latches 18(a) or 18(b) at the upper front side and a tab similar to rear side tabs 22(a) and (b) at an upper rear side. Accessory boxes 3 have an overall area (defined on the upper or lower surfaces) of about one quarter that of the area of upper surface 16. Large container 5 is similarly in structure to container 60(b) described above having a base and a cover, with steps formed on the lower left and right sides of the base and spring loaded latches formed on the left and rights side of the cover. Large container 5 has an area which is about one half that of the area of upper surface 16. Finally small container 4 has a structure similar to that of large container 5, with an area of about one half that of the area of upper surface 16, but with a smaller depth than larger container 5.

With reference to FIGS. 8D, 8E and 8F, two accessory boxes 3 are disposed on the right side of drawer storage module 10. In FIG. 8D, the accessory boxes 3 are orientated such that the front sides thereof are adjacent each other near the longitudinal vertical central plane of module 10 such that when the lids of boxes 3 are opened, one of the lids extends vertically above front long side 12(a) and the other lid extends vertically above rear long side 12(b) of drawer storage module 10. When the lids are opened in this configuration, the interior surfaces thereof (that is, the surfaces which face the interior accessory storage volumes when the lids are closed) face each other. In other words, accessory boxes 3 are both opened to face inwardly towards the longitudinal vertical central plane. In FIG. 8E, the orientation of the front accessory box 3 is reversed such that when the lid thereof is opened it extends vertically over the longitudinal vertical central plane of storage module 10. In this situation, the exterior surface of the lid of the front accessory box 3 faces the interior surface of the lid of the rear accessory box 3. In other words, the rear accessory box 3 is opened to face inwardly and the front accessory box 3 is opened to face outwardly, or in still further words, both boxes 3 are opened to face forwardly. In FIG. 8F the front sides of both accessory boxes 3 are oriented so as to be disposed over the longitudinal vertical central plane such that the lids are opened in the opposite orientation, with the exterior surface of one lid facing and adjacent to the exterior surface of the other lid. In other words, both the front and rear accessory box 3 are opened to face outwardly, or in still further words, front accessory box 3 is opened to face forwardly and rear accessory box 3 is opened to face rearwardly. Though only two boxes 3 are shown, two additional boxes could be secured on the left side of surface 16 such that a total of four accessory boxes 3 can be secured on drawer storage module 10.

In FIGS. 8G, 8H and 8I, two small containers 4 are disposed on surface 16, with one container disposed on each of the left or right side of the surface. One step of each smaller container 4 is secured beneath one of rear tabs 22(a) or 22(b), and the other step of each small container 4 is secured beneath the associated spring-loaded latch 18(a) or 18(b). Containers 4 each thus extend entirely across one half of upper surface 16 in the lateral direction, and open to face leftward or rightward, as opposed to the forward or rearward opening directions of accessory boxes 3. In FIG. 8G, containers 4 are disposed such that the lids are adjacent to each other when opened, at a location above the lateral central vertical plane of storage module 10. Therefore, the exterior surfaces of the lids face each other and the containers open outwardly in the same manner as described in FIG. 8F but in the left and right directions. In FIG. 8H, the orientation of the right side container 4 is reversed such that the lid thereof extends vertically over short right side 14(b) and the interior surface of the lid of the right side container 4 faces the exterior surface of the lid of left side container 4 when the lids are open. In other words, the left small container 4 is opened to face outwardly and the right small container 4 is opened to face outwardly, or in still further words, both containers 4 are opened to face leftward. In FIG. 8I, the orientation of left side container 4 is reversed such that the lid thereof extends over short left side 14(a), and the interior surfaces of both lids face each other. In other words, both small containers 4 are opened to face inwardly.

FIGS. 8J, 8K and 8L show similar orientations as FIGS. 8G, 8H and 8I but for large container 5. In each of the drawings, the lids are shown in the closed position. The orientation shown in FIG. 8J is the same as in FIG. 8I, the orientation shown in FIG. 8K is the opposite of FIG. 8H and the orientation of FIG. 8L is the same as FIG. 8G.

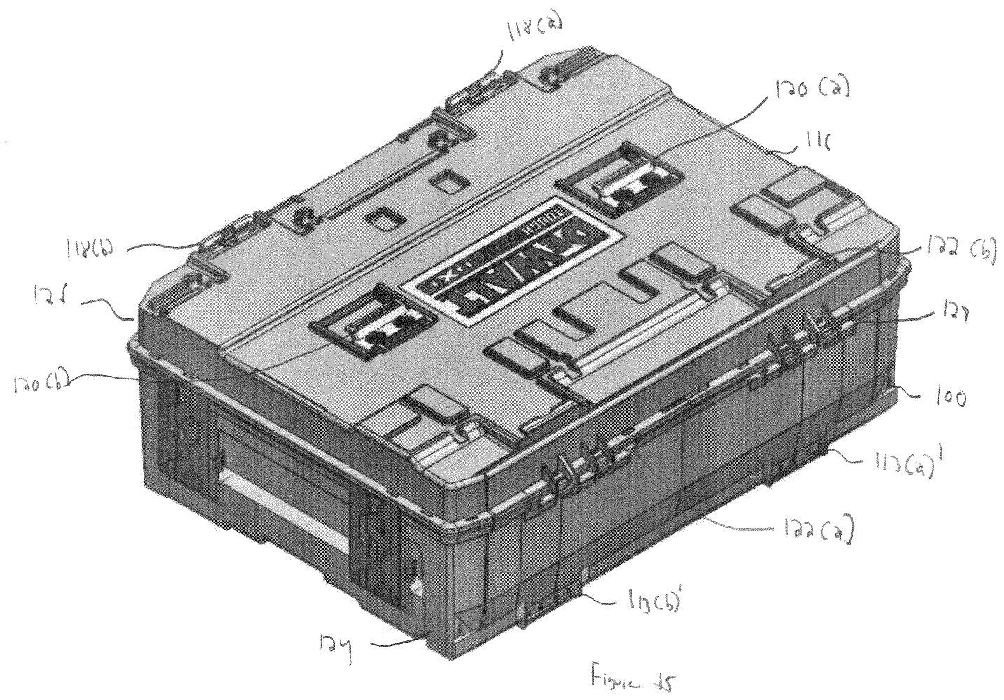

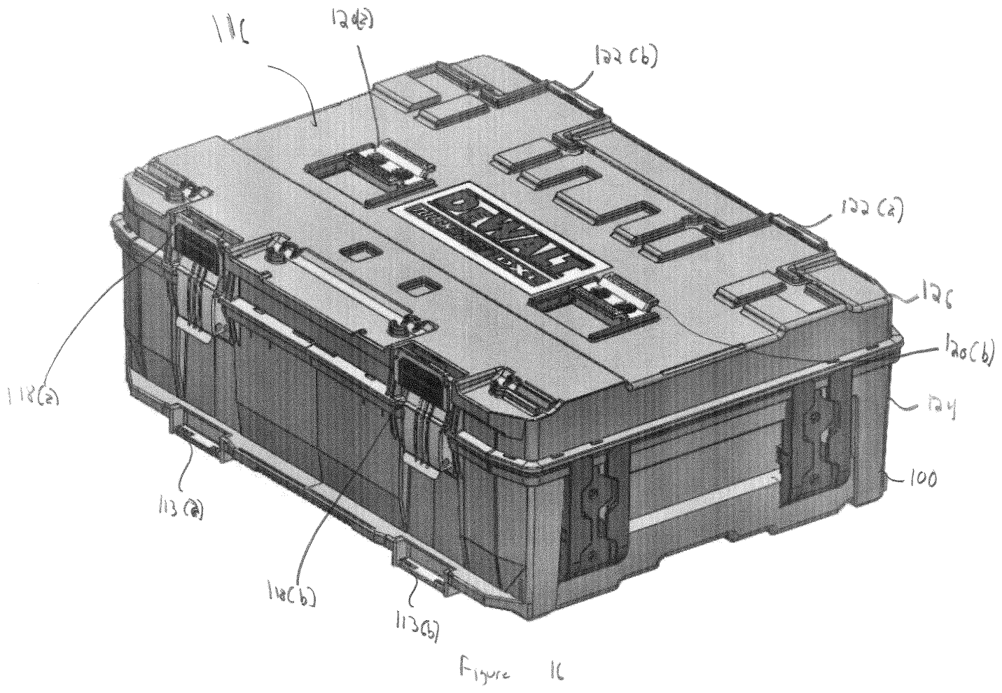

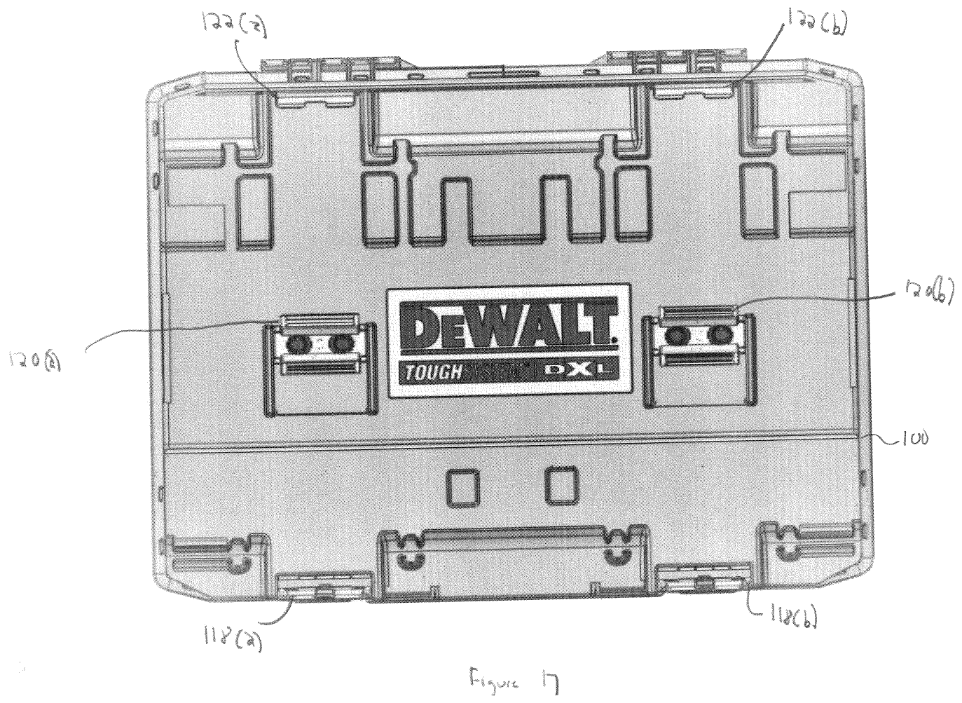

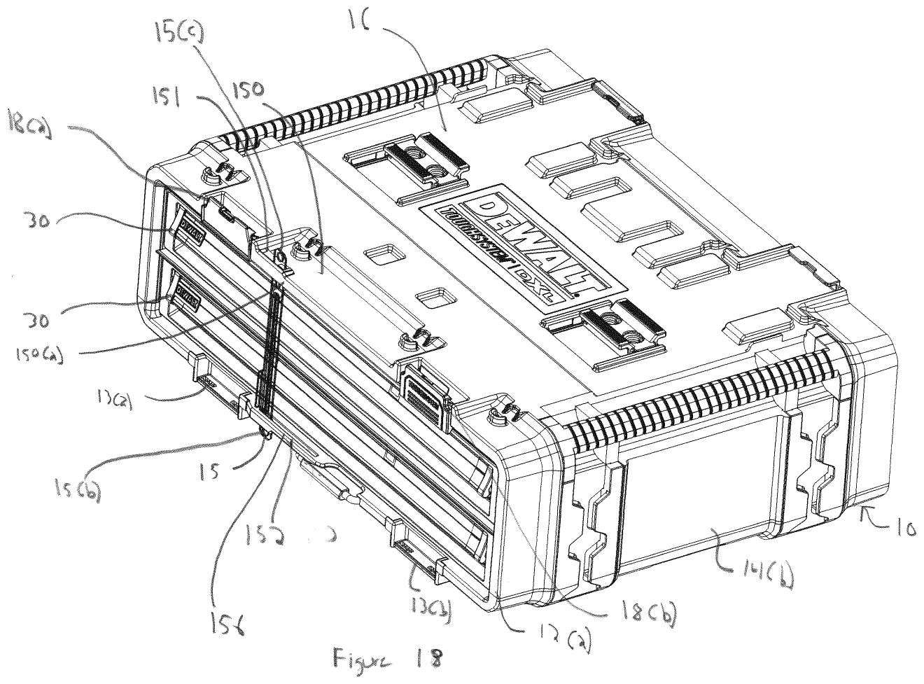

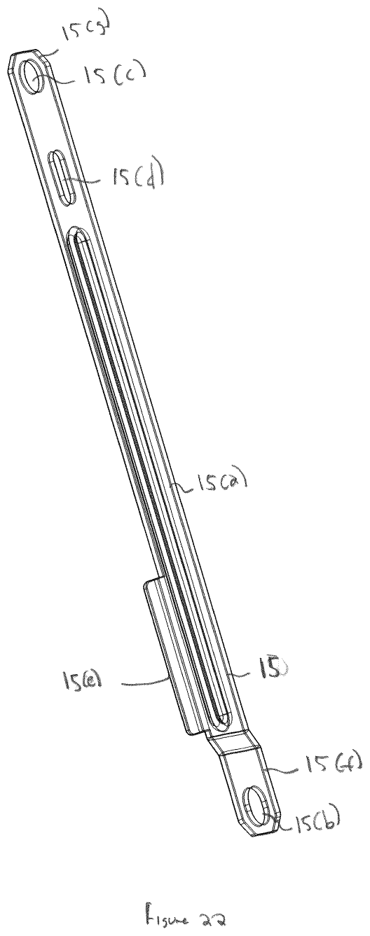

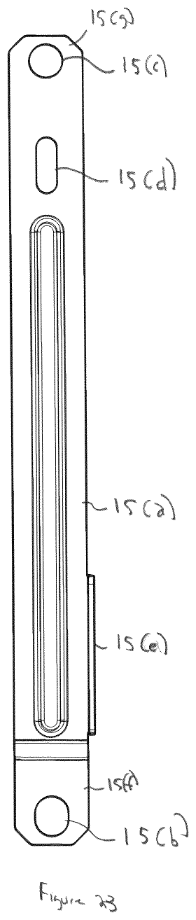

With reference to FIGS. 9A-9F, block diagrams are shown which illustrate the possible sizes and orientations of containers of various sizes which may be stacked on drawer storage module 10. The containers in each case are shown in block form. In FIG. 9A, a full sized component, which may be another drawer storage module 10 or container 100 described below with reference to FIGS. 15-17, is secured on a lower module 10 and extends entirely across upper surface 16. The component incudes four lower steps and is secured between both pairs of rear side tabs 22(a),(b) and spring loaded latches 18(a),(b). In FIG. 9B, a container having a slightly less width than that of the container shown in FIG. 9A such that is does not extend entirely across upper surface 16 is shown. The container in FIG. 9B also includes four lower steps to be secured between both pairs of rear side tabs 22(a),(b) and spring loaded latches 18(a),(b) in the same manner as the container in FIG. 9A. In FIG. 9C, two thin boxes having widths which are less than containers 4 or 5 have left and right steps formed on the lower sides and each extend across the left and right sides of upper surface 16, with each box secured between one pair of side tabs 22(a),(b) and spring loaded latches 18(a),(b). In FIG. 9D, two half sized containers extend laterally across the front and rear areas of upper surface 16. The rear container in FIG. 9D is secured between both side tabs 22(a) and 22(b) and respective sliding tabs 20(a) and 20(b), while the front box is secured between sliding tabs 20(a) and 20(b) at the opposite ledge and spring loaded latches 18(a) and 18(b). In FIG. 9E two containers are disclosed in the same orientation as the containers in FIG. 9C, however the containers are half sized containers and have a larger width. In FIG. 9F, four quarter sized containers are shown and with each of the rearward containers secured between one of rear side tabs 22(a) or 22(b) and an associated sliding tab 20(a) or 20(b), and each of the front containers secured between one of sliding tabs 20(a) or 20(b) and the associated spring loaded latch 18(a) or 18(b).

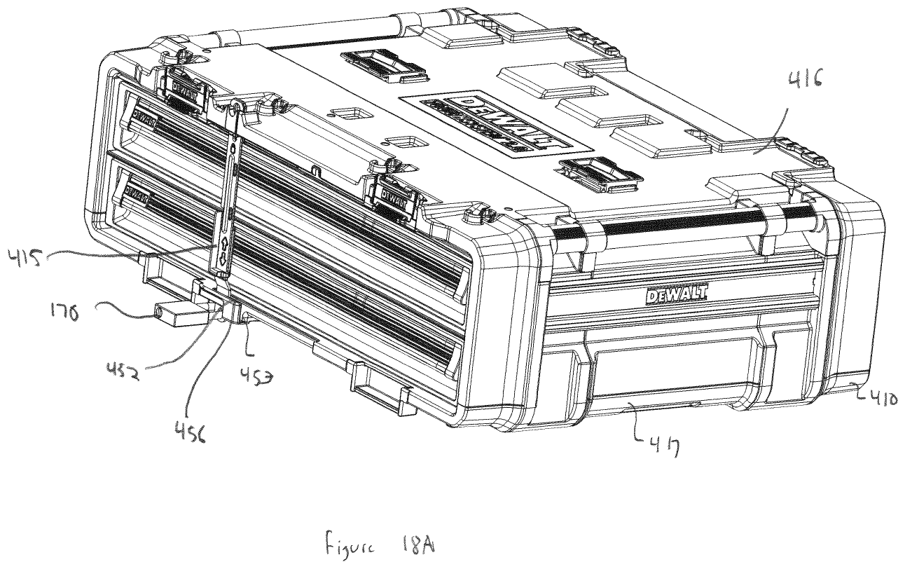

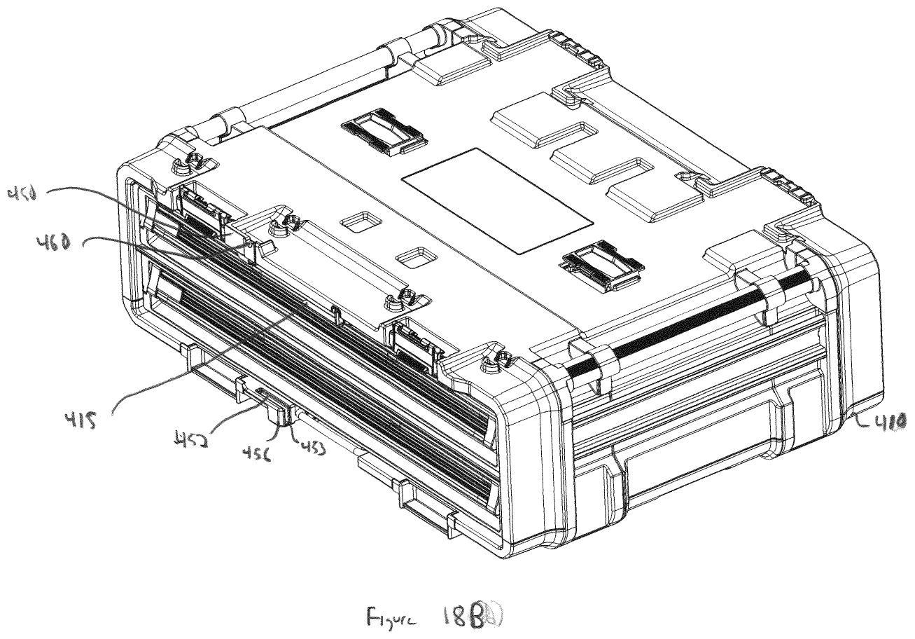

With reference to FIGS. 10A-10B, the manner in which containers which extend only half-way across upper surface 16 in the lateral direction are secured to upper surface 16 is shown (for example, the orientation shown in FIGS. 8D-8F and FIG. 9F). In particular quarter-sized small accessory boxes 3 having front and rear lower steps are shown. A first accessory box 3 is placed on upper surface 16 with one of the lower steps slid beneath the overhanging ledge of either rear left side tab 22(a) or rear right side tab 22(b). Thereafter, the associated sliding tab 20(a) or 20(b) is slid rearwardly in indentation 25(a) or 25(b) such that rear overhanging hook or ledge 27′ overlies the other lower step of small container 3 to secure small container 3 on upper surface 16 at a rearward location, as shown in FIG. 10A. Thereafter, a second accessory box 3 is placed on upper surface 16 at a location forward of the first accessory box 3, with one lower step of second accessory box 3 disposed beneath front overhanging hook or ledge 27′ of the associated sliding tab 20(a) or 20(b). Thereafter, the forward portion of second accessory box 3 is brought down into full contact with upper surface 16 such that the opposite step of accessory box 3 contacts and slides over the associated spring loaded latch 18(a) or 18(b) to be secured beneath the latching hook thereof, in the manner described in the above-referenced incorporated patent applications and patent to fully secure the second accessory container 3 on upper surface 16 as shown in FIG. 10B. The procedure may be repeated on the other side (left or right) of upper surface 16 such that four quarter-sized accessory boxes 3 can be secured on upper surface 16. (Latches 18(a),(b) are not shown in FIGS. 10A-B.) Although a quarter size accessory box is described, quarter sized small containers could also be secured in this manner.

Alternatively, as described above, two half-sized containers (4 or 5) can be secured on upper surface 16. In each case the lower step of the containers would be disposed beneath one of left side tab 22(a) or right side tab 22(b) and the container would be lowered towards upper surface 16 with the other step of the container (4 or 5) contacting and sliding over the respective left spring loaded latch 18(a) or right spring loaded latch 18(b) to be secured beneath the latching hook thereof as described above. A second large container could be disposed on the opposite side of upper surface 16 to extend between the other of the side tabs and latches. The containers 4 would have a channel formed on the lower surface thereof to receive tabs 20(a) and 20(b) to allow the lower surfaces of the containers (4 or 5) and upper surface 16 to come into contact. Although containers which extend laterally across the left or right side of upper surface 16 are shown, containers which extend fully across the front or rear sides of upper surface 16 could also be incorporated. In the latter case, the steps of the containers would be formed on the lower front and rear sides, as opposed to the lower left and right sides.

With reference to FIG. 11 an alternative structure is disclosed. Drawer storage module 10′ includes sliding tab 200 which includes front and rear overhanging ledges 270 which have a similar structure to ledges 27′. Tab 200 is slidably disposed in indentation 250 which includes an inclined ramp 252. Tab 200 is shown in its forward position (closer to front long side 12(a) in which it is vertically displaced to the maximum extent relative to indentation 250 with overhanging ledges 270 displaced from upper surface 160. When sliding tab 200 is moved rearwardly in indention 250, it slides down ramp 252 such that ledges 270 are in substantially the same plane as upper surface 160, with rear ledge 270 disposed beneath ledge 254. Therefore, tab 200 does not interfere with the lower surface of an upper module or box when it is disposed on upper surface 160 so that no channel is needed in the lower surface of the upper container, box or module. In all other respects, drawer storage module 10′ would have the same structure as drawer storage module 10.

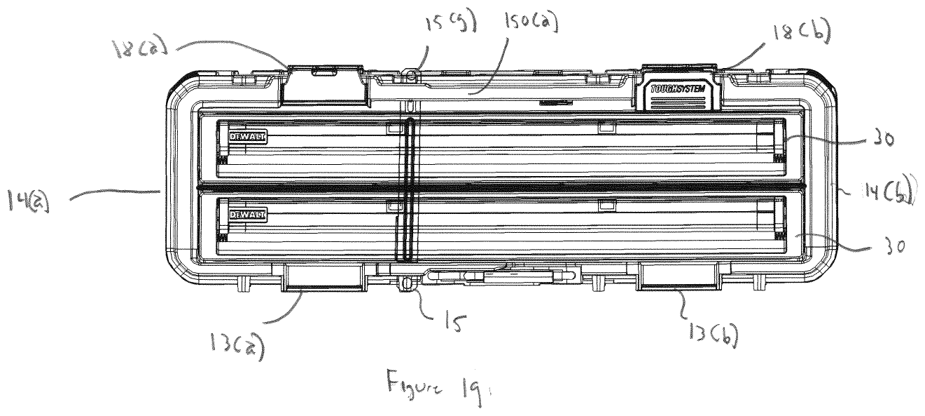

With reference to FIG. 12, several views of the upper surface of a further alternative structure is disclosed. Drawer storage module 10″ includes tab 300 which is rotatably secured in circular indentation 325 formed on upper surface 316 of the drawer storage module. Tab 300 includes two ledges 327(a) and 327(b) and rotates about axis 341. In order to secure a quarter-sized box on upper surface 316, tab 300 is placed in its initial position in which the longer dimension thereof extends along the longitudinal axis of upper surface 160. That is, left and right ledges 327(a) and 327(b) each face towards one of the left and right short surfaces of the drawer storage module. A quarter-sized container or box is then place on upper surface 316 on a rearward portion thereof, that is, in one of the rear quarter regions, with the rear lower stop of the container or box received under the overhanging ledge of one of the rear tabs having the same structures as tabs 22(a),(b). This position is marked as “1” in FIG. 12 in the lower left quadrant, and tab 300 extends longitudinally along and out of contact with the step. Thereafter tab 300 is rotated such that one of ledges 327(a) or 327(b) is disposed over the lower step of the container to thereby secure the container on surface 316, as shown in the lower center and lower right quadrant of FIG. 12 (and marked as 2). Thereafter, a second quarter sized container can be disposed between the other of ledges 327(a) or 327(b) and one of the spring loaded latches. In all other respects, drawer storage module 10′ would have the same structure as drawer storage module 10.

With reference to FIGS. 15-17, a further embodiment of the invention is shown. Container 100 includes base 124 having an interior storage volume and cover 126 pivotably attached to base 124 about conventional pivot hinges and rods shown generally as element 127 to open and close the interior storage volume. Cover 126 has upper surface 116 extending between left and right short sides and front and rear long sides. Left spring loaded latch 118(a) and right spring loaded latch 118(b) are disposed on the front long side of cover 126 and have structures and locations substantially identical to left spring loaded latch 18(a) and right spring loaded latch 18(b) as described in the first embodiment. Base 124 includes front left step 113(a) and front right step 113(b) which extend downwardly from the lower edge of the front long side at a location below left latch 118(a) and right latch 118(b), respectively, and include a ledge. The structure and locations of steps 113(a) and 113(b) are similar to steps 13(a) and 13(b) as described in the first embodiment. Left and right upper rear side tabs 122(a) and 122(b) are formed on the rear long side of cover 126 at locations generally opposite left and right spring loaded latches 118(a) and 118(b), respectively, and have a structure and locations similar to left and right rear side tabs 18(a) and 18(b) as described in the first embodiment. Left and right sliding surface tabs 120(a) and 120(b) are disposed on upper surface 116 and generally extend along a central vertical plane which extends along the longitudinal direction and which bisects container 100. Left sliding surface tab 120(a) is disposed between left spring loaded latch 118(a) and left side rear tab 122(a) and right sliding surface tab 120(b) is disposed between right side spring loaded latch 118(b) and right rear side tab 122(b). Left and right sliding surface tabs 120(a) and 120(b) have a structure and locations similar to left and right sliding surface tabs 20(a) and 20(b) described in the first embodiment. Base 124 includes rear lower left step 113(a)′ and rear lower right step 113(b)′ which extend downwardly from the lower edge of the rear long side below left upper rear side tab 122(a) and right upper rear side tab 122(b), respectively. The structure and location of steps 113(a)′, 113(b)′ are similar to steps 13(a)′ and 13(b)′ described in the first embodiment.

Container 100 may be stacked upon other containers 100 and on top of or beneath drawer storage module 10 in the same manner as described above with respect to the stacking of drawer storage modules 10. In addition, accessory boxes 3, small containers 4 and large containers 5 may be secured on surface 116 in the same manner as shown and described with respect to drawer storage module 10 in FIGS. 8A-8L. The orientations in which various sized containers may be secured to surface 16 as described in FIGS. 9A-9F is also applicable to container 100. Sliding surface tabs 120(a) and 120(b) function as shown and described with reference to FIGS. 10A-10B and sliding surface tabs 20(a) and 20(b) to secure the various sized containers on surface 116.

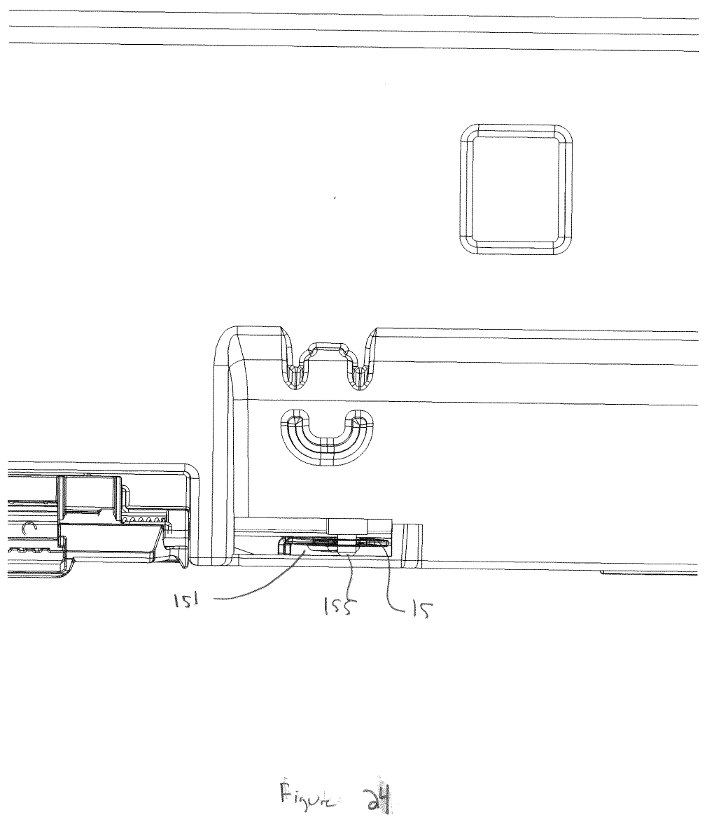

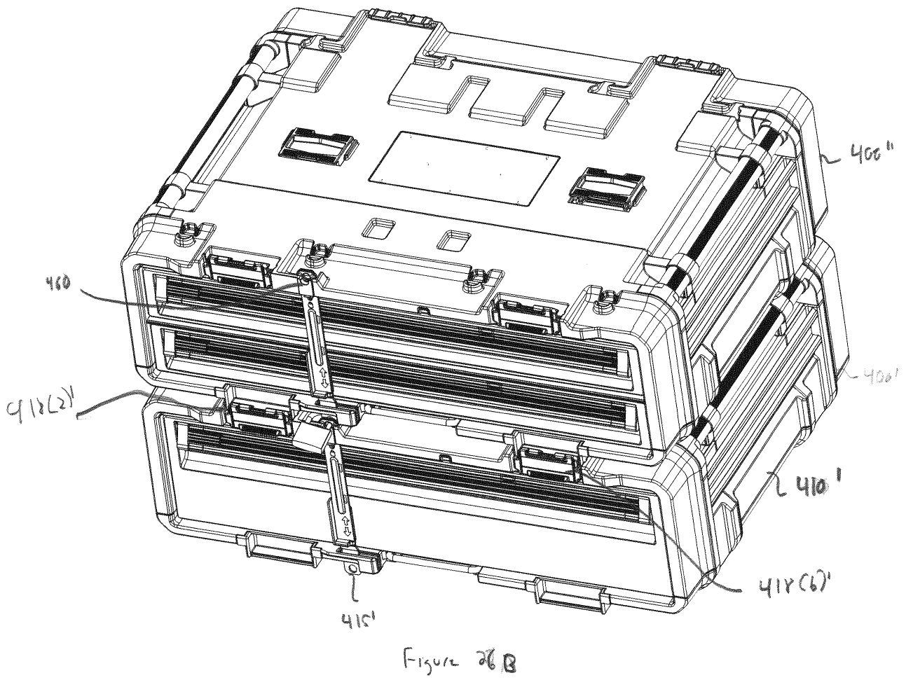

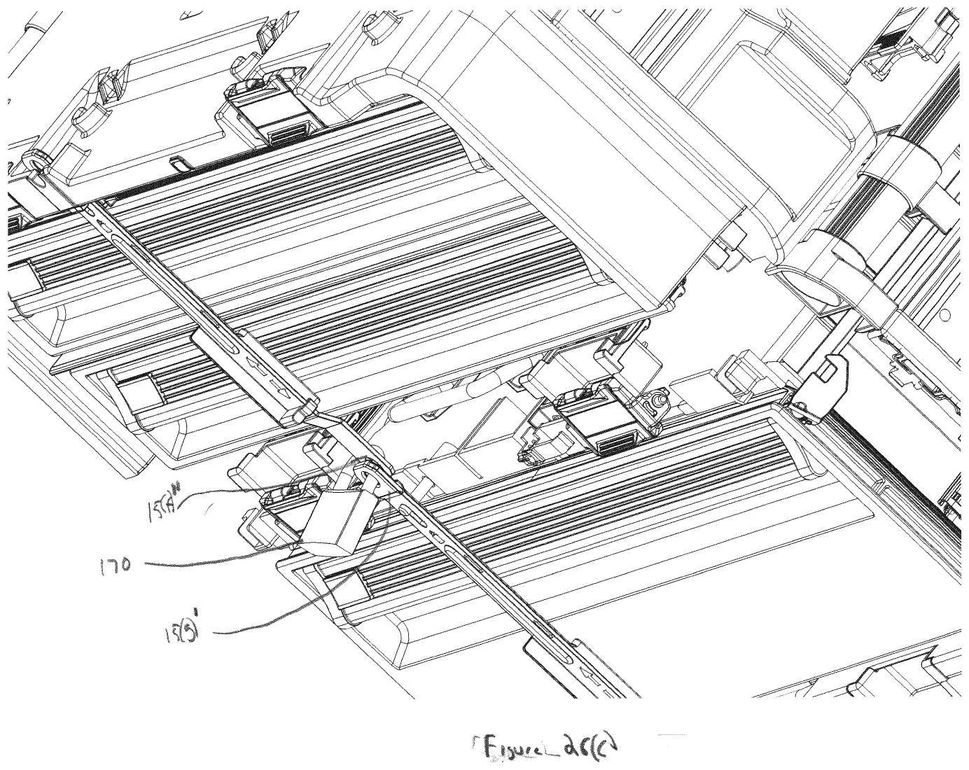

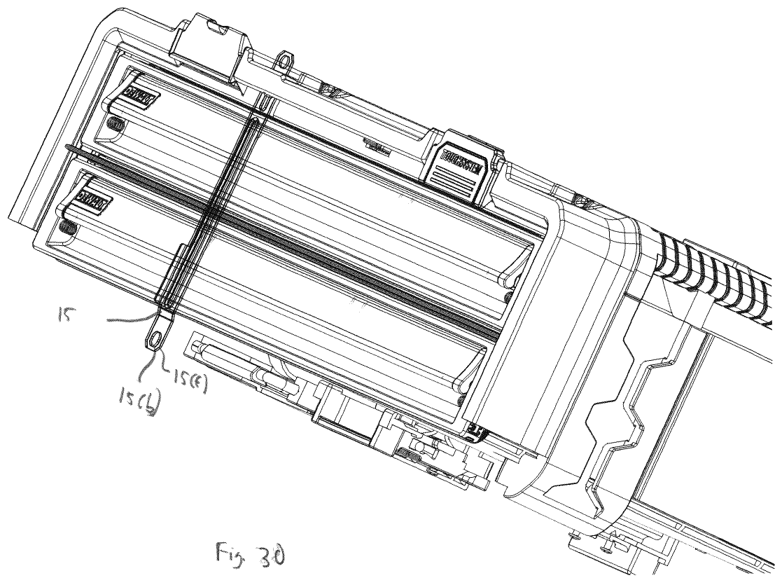

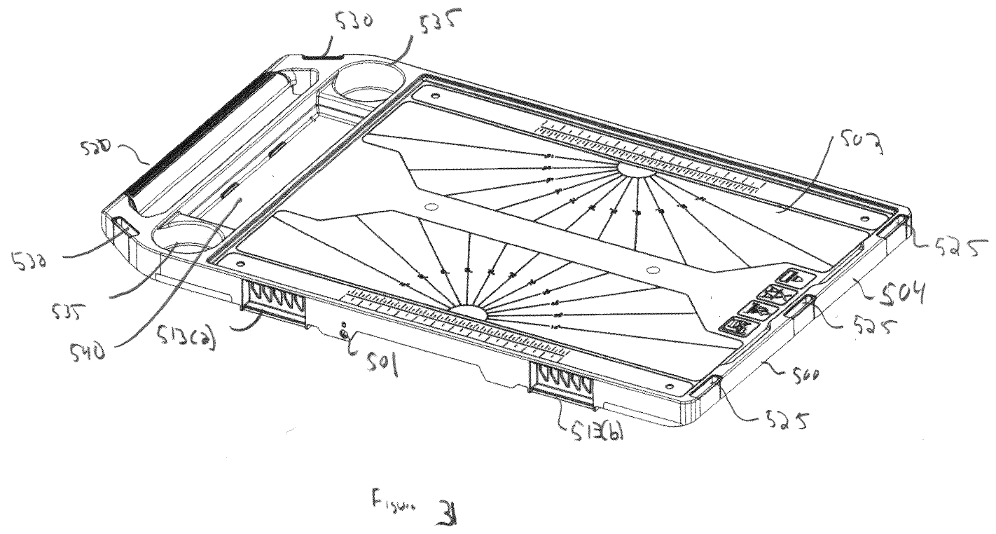

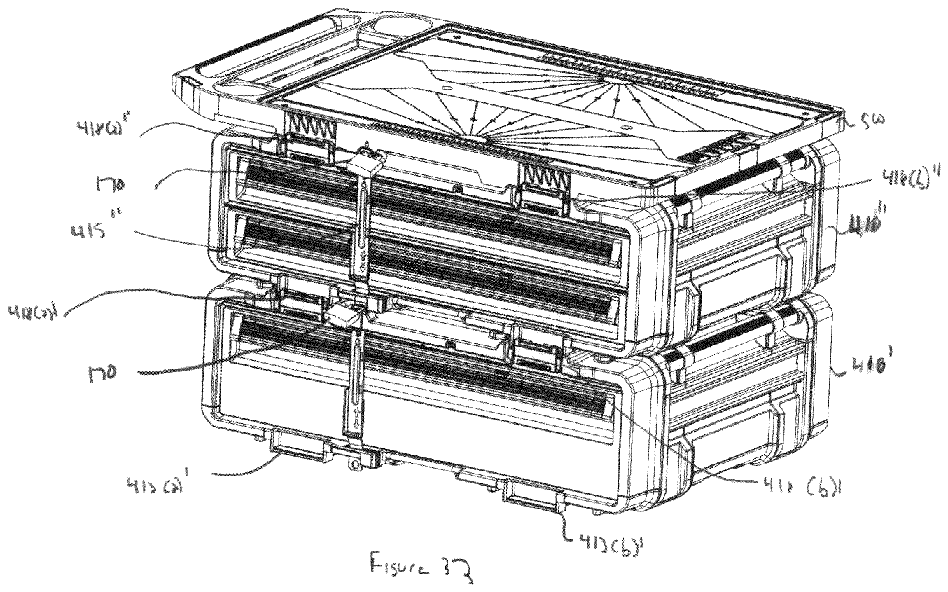

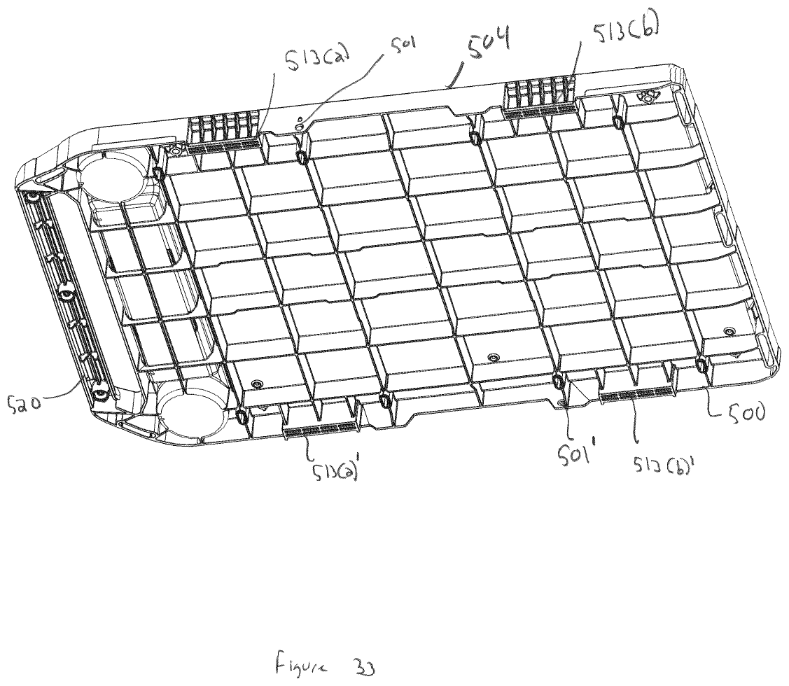

With reference to FIGS. 18-30, the structure and functioning of locking bar 15 will be explained. With particular reference to FIGS. 21-23, locking bar 15 includes vertically extending portion 15(a) having tab 15(f) projecting rearwardly at its lower end. Lower circular through opening 15(b) is formed in tab 15(f). Side tab 15(e) projects forwardly from vertically extending portion 15(a) for a limited extent of the length thereof. Upper circular through opening 15(c) is formed adjacent upper end 15(g) of vertically extending portion 15(a). Oval through opening 15(d) is formed at a location below circular through opening 15(c).

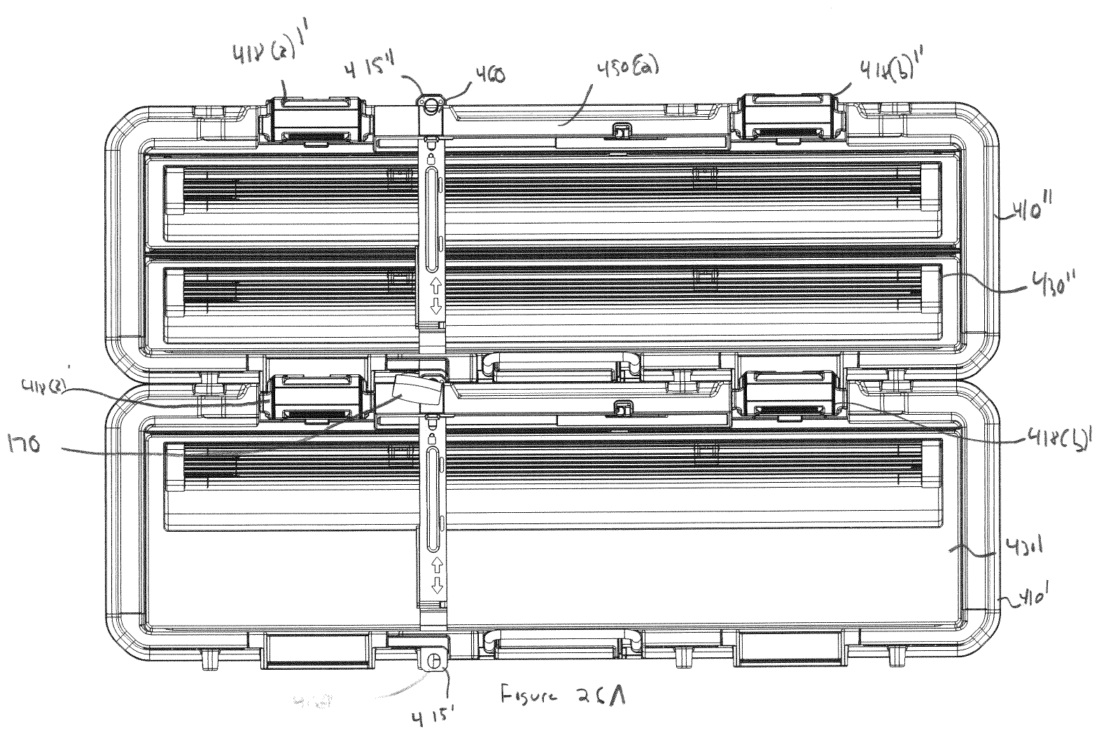

With further reference in particular to FIGS. 18-20, upper surface 16 of drawer storage module 10 includes indented rectangular region 150 formed adjacent front long side 12(a) and extending between left spring loaded latch 18(a) and right spring loaded latch 18(b). Indented region 150 includes vertical wall 150(a) formed at the forward edge thereof and forming part of front long side 12(a). Vertical wall 150(a) extends forwardly of the outer surface of drawers 30 when they are fully inserted into drawer storage housing 11. Upper surface through slot 151 is formed at a forward left side location of region 150, and is disposed at a location above and slightly forward of drawers 30 when they are fully inserted into drawer storage housing 11. With reference to FIGS. 20 and 24, pin 155 is disposed within slot 151, and extends through oval opening 15(d) to allow locking bar 15 to both pivot in a vertical plane between a vertical position and a horizontal position, and to move slightly vertical for the linear extent of oval opening 15(d). Lower ledge 156 forms part of front long side 12(a) and is disposed between left step 13(a) and right step 13(b). Lower ledge 156 includes lower surface slot 152 formed vertically therethrough at a location below and slightly forward of drawers 30, and is disposed beneath upper surface through slot 151. However, lower surface slot 152 is longer than upper surface slot 151 and is slightly closer to the outward sides of drawers 30.

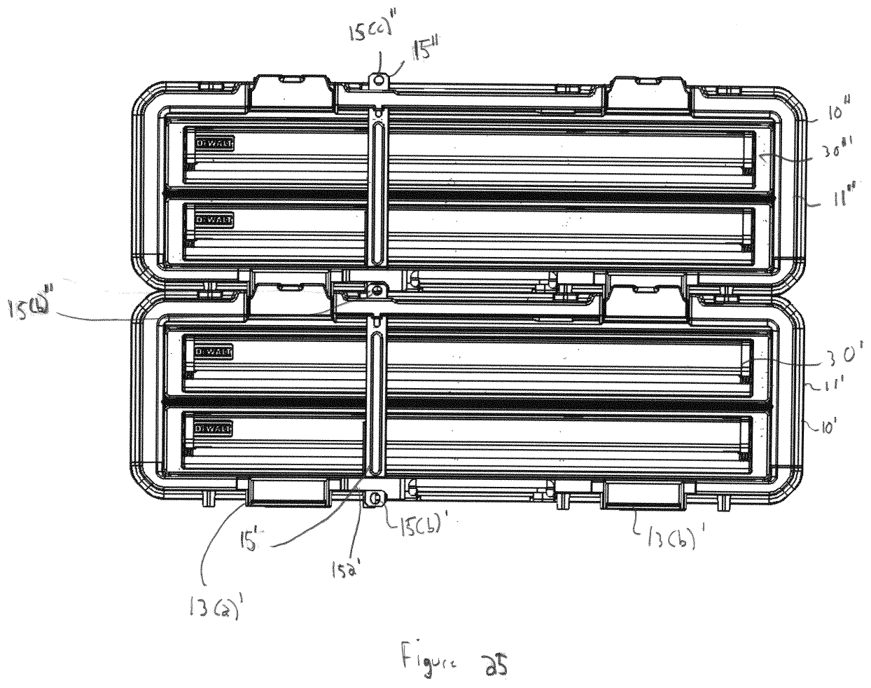

With reference to FIG. 19, locking bar 15 is disposed vertically with upper end 15(g) and upper circular through opening 15(c) extending upwardly and clear of vertical wall 150(a), and tab 15(f) and lower circular though opening 15(b) extending through and clear of lower surface slot 152. In particular, in this orientation lower circular through opening 15(b) is disposed below lower ledge 156 and upper circular opening 15(c) is disposed above upper surface upper through slot 151. Locking bar 15 is disposed over the outer surfaces of drawers 30 to prevent them from being opened. Side tab 15(e) rest upon lower surface projecting ledge 156 and extends perpendicularly to lower surface slot 152 to limit downward movement of locking bar 15 so that it cannot be moved completely through slot 152. With reference to FIGS. 27 and 28, locking bar 15 can be pivoted in a vertical plane about pin 155, with tab 15(f) passing through lower surface slot 152, to an upper position where it is disposed substantially horizontally above and clear of both drawers 30, to allow drawers 30 to be withdrawn. In the upper position, locking bar 15 is disposed behind vertical wall 150(a). Locking bar 15 can be raised before pivoting if required due to oval slot 15(d) having a larger dimension than the diameter of pin 155 to allow it to clear slot 150. In its upper most position, locking bar 15 is disposed substantially horizontally and can be received generally behind vertical wall 150(a).

With further reference to FIGS. 18A-B and 26A-B, an alternative version of the drawer storage module is shown. Drawer storage module 410 includes lower ledge 456 having slot 452 formed therein through which locking bar 415 having the same structure as locking bar 15 extends. Slot 425 is open at one end via vertical through opening 453 to allow the lower end of locking bar 415 to be moved therethrough to allow pivoting. Module 410 also includes upper semi-circular notch 460 formed in vertical wall 450. As discussed further below, the hasp of padlock 170 fits within notch 450. In all other respects, module 410 is identical to drawer storage module 10 described above. With further reference to 26A-B in particular, which shows upper module 410″ stacked on lower module 410′, lower module 410′ may include only a single drawer 430′ as opposed to upper and lower drawers 430″ shown with respect to upper module 410″.

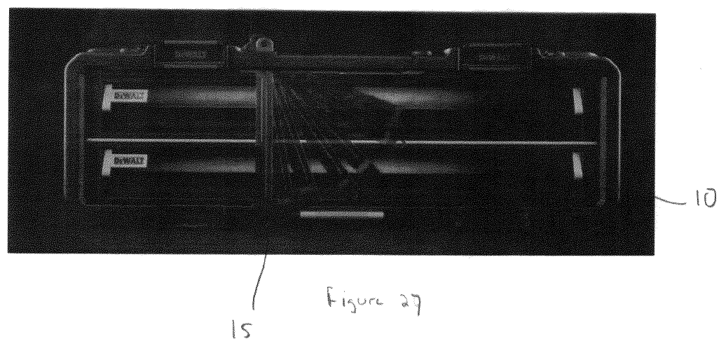

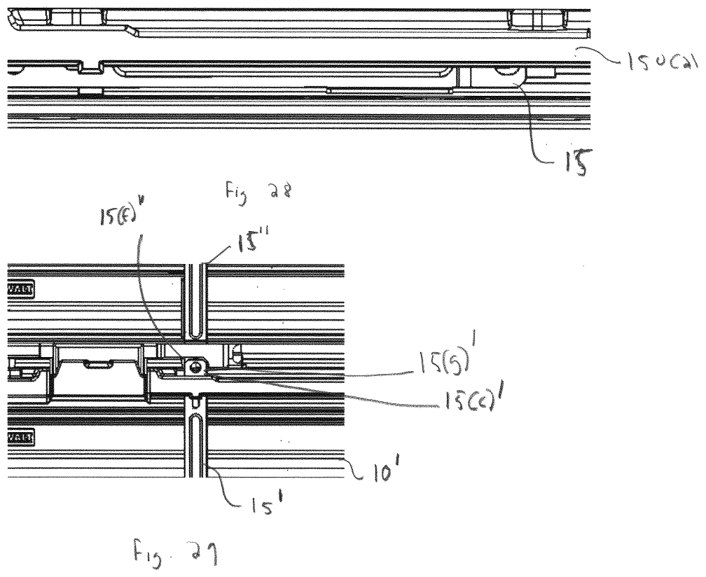

With further reference to FIGS. 25, 26A-C and 29, one drawer storage module 10″ may be stacked on another drawer storage module 10′, or alternatively, with respect to FIGS. 26A-B one drawer storage module 410″ may be stacked on another drawer storage module 410′. In each case, steps 13(a)″, 13(b)″ (or 413(a)″,413(b)″) are secured under corresponding latches 18(a)′,18(b)′ (or 418(a),418(b)′) to secure the upper module on the lower module. (Since locking bar 415 has an identical structure to locking bar 15, separate numbers for the parts of locking bar 415 are not shown in all cases, and since certain elements of the invention are not visible in the stacked configuration, the non-prime reference number will be used to refer to them with respect to other figures where such elements are visible with the understanding that the structures are identical.) In particular a first (upper) drawer storage module, designated 10″ or 410″, may be stacked on a second (lower) drawer storage module, designated 10′ or 410′, with lower surface 17 or 417 of upper drawer storage module 10″ or 410″ resting upon upper surface 16 or 416 of lower drawer storage module 10′ or 410′. Tab 15(f)″ of locking bar 15″ of upper module 10″ rests behind upper end 15(g)′ of locking bar 15′ of lower module 10′ or 410′, with upper circular opening 15(c)′ of locking bar 15′ overlying lower circular opening 15(b)″ of locking bar 15″, as shown in close up in FIG. 26C. Padlock 170 may be disposed through both lower circular opening 15(b)″ of locking bar 15″ and upper circular opening 15(c)′ of locking bar 15′ to secure drawer storage module 10′ or 410′ to drawer storage module 10″ or 410″.

Additionally, padlock 170 precludes pivoting motion of both locking bars 15′ and 15″. In particular, since the hasp of padlock 170 is secured though lower circular opening 15(b)″ of locking bar 15″ of upper drawer storage module 10″ or 410″, upper end 15(g)′ of locking bar 15′ cannot pivot about pin 155. That is, padlock 170 utilizes upper locking bar 15″ to provide a stationary lock base to lock locking bar 15′ of the lower module in the vertical position, limiting upward motion of locking bar 15′ and thereby precluding the lower end 15(f)′ from being pivoted out of slot 152′ or 452′ to ensure that drawers 30′ of lower module 10′ or 410″ are secured within drawer housing 11′. Furthermore, since padlock 170 cannot fit through lower surface slot 152″ of upper drawer storage module 10″ or slot 452 of module 410″, upper locking bar 15″ also cannot be raised or pivoted to the horizontal position and drawers 30″ are secured within drawer housing 11″. That is, padlock 170 simultaneously utilizes lower locking bar 15′ to provide a stationary lock base to lock upper locking bar 15″ in the vertical position. Therefore, a single padlock 170 serves to lock the drawers (30′, 30″) of both lower drawer storage module 10′ and upper drawer storage module 10″ (or 410′ and 410″) in the closed and non-withdrawable position, in addition to locking modules 10′ and 10″ (or 410′ and 410″) to each other.

In addition to locking to drawer storage modules together as described above, padlock 170 can also be utilized with one drawer storage module 10 or 410 to secure locking bar 15 in the vertical position overlying and locking drawers 30 within housing 11. With reference to FIG. 18(A), padlock 170 may be disposed though lower circular through opening 15(b). Since the hasp of padlock 170 cannot move through lower surface slot 452, locking bar 15 cannot be pivoted from the vertical position and is locked in the position overlying locking drawers 30. In addition, the haps of padlock 170 is also secured behind (as considered in the lateral direction) lower ledge 456 and lower ledge 456 also serves to preclude pivoting motion of locking bar 15 and secure it over locking drawers 15.

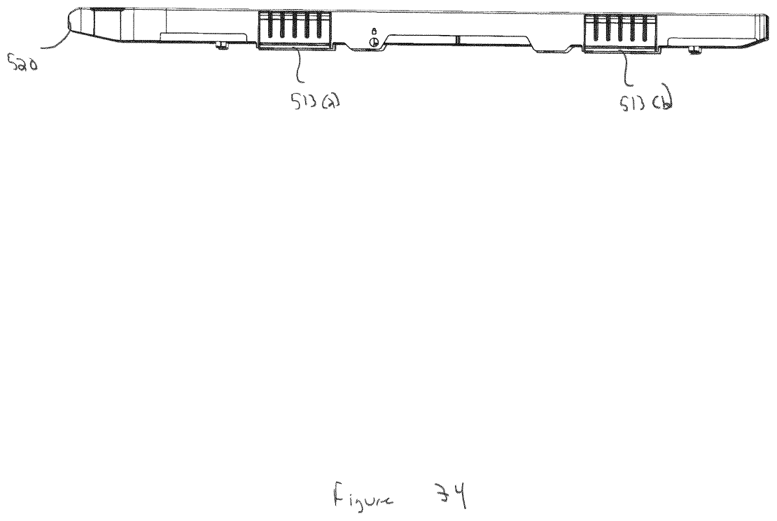

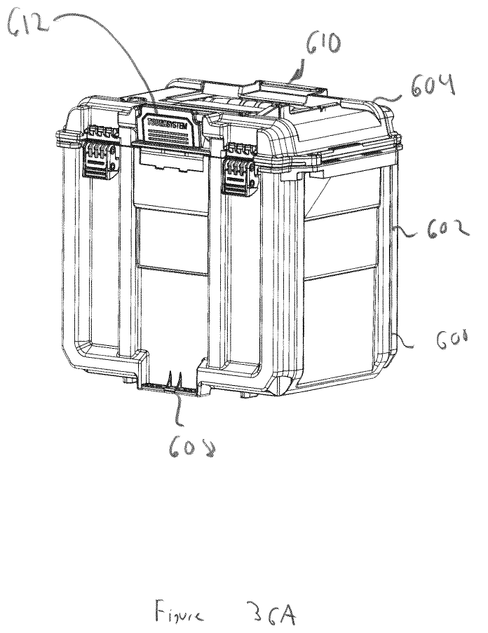

With reference to FIGS. 31, 33 and 34, work platform 500 is shown. Work platform 500 also includes upper work surface 502, and peripheral rim 504 extending downwardly from upper work surface 502. Spaced carry handle 520 is formed at one end. Peripheral rim 504 includes left and right front steps 513(a) and 513(b), and left and right rear steps 513(a)′ and 513(b)′. Front through opening 501 is formed through peripheral rim 504 at a location longitudinally inward of front left step 513(a) and rear through opening 501′ is formed at a location longitudinally inward of right rear step 513(b)′. Three slots 525 extend laterally across upper surface 502 at the right edge, and two corner slots 530 are formed at the front and rear corners. Slots 525 and 530 may be used to secure belt clip tools. Cups holders 535 are formed adjacent slots 525, and laterally extending depression 540 extends between cup holders 535 and may be used as a storage area.

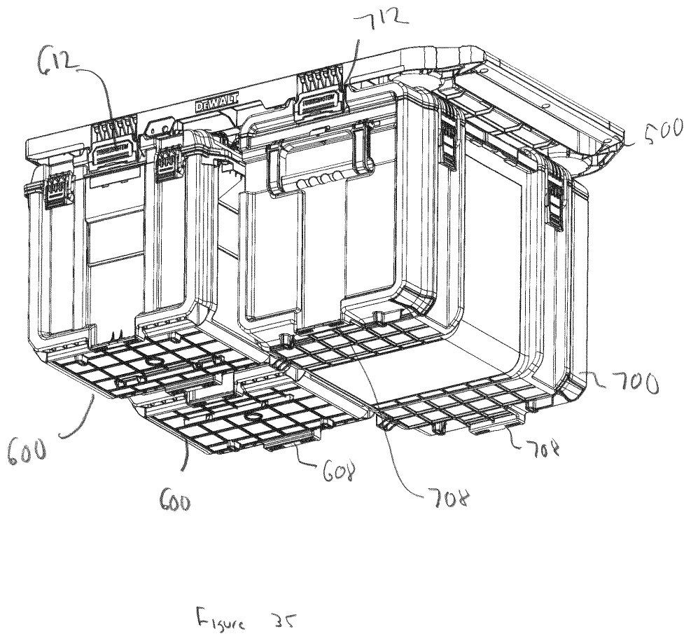

With reference to FIGS. 32, work platform 500 may be secured on top of upper drawer storage module 410″ with left latch 418(a)″ resting on step 513(a) and right latch 418(b)″ resting on step 513(b), and rear steps 513(a)′ and 513(b)′ disposed beneath left and right upper rear side tabs (such as tabs 22(a) and 22(b)) to secure and retain work platform 500 on module 410″ with handle 520 extending to the left. Front opening 501 is adjacent and aligned with the upper opening of lock bar 415″ (having the same structure as lock bar 15). The hasp of padlock 170 is secured through front opening 501 and the upper opening of lock bar 415″ to prevent platform 500 from being removed from module 410″. Work platform 500 can also be disposed on upper drawer storage module with handle 520 extending to the right, with the hasp of padlock 170 secured through rear opening 501′.

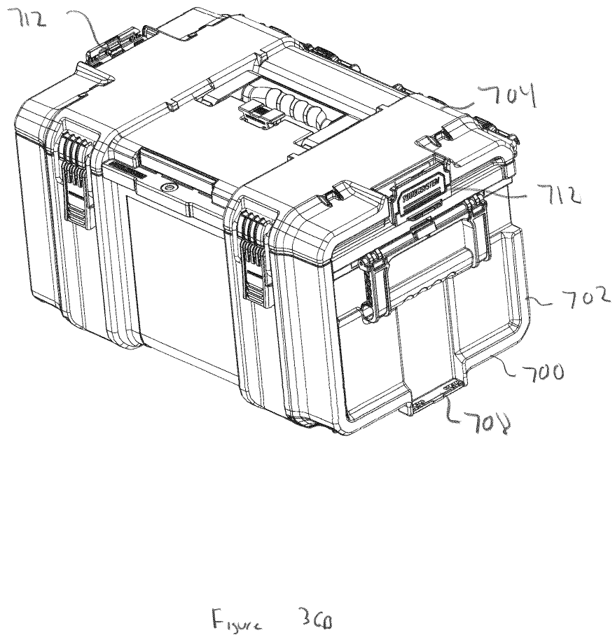

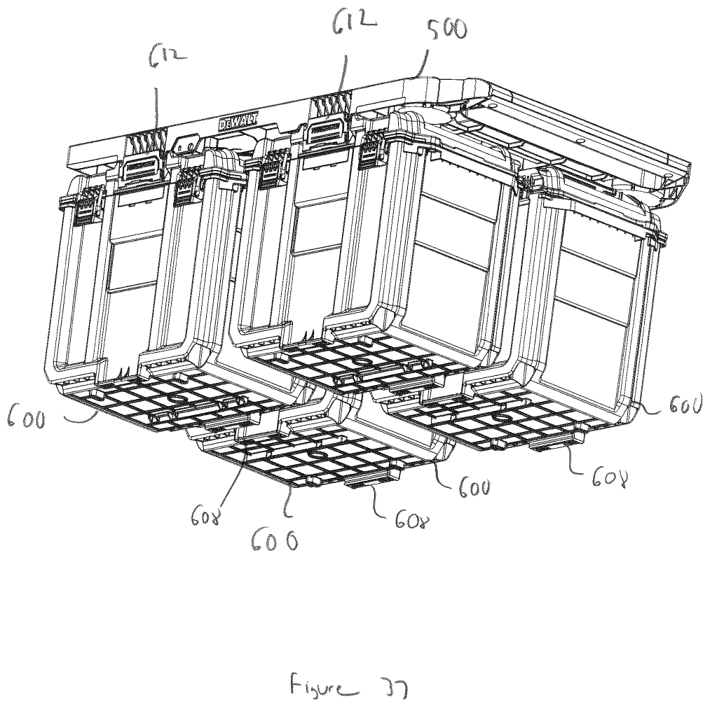

With reference to FIG. 36A, quarter-sized storage container 600 is shown. Container 600 includes storage base 602 and cover 604 pivotably secured on storage base 600. Step 608 extends downwardly from the lower surface of base 602 along the front longitudinal side thereof. A similar step extends down from the rear longitudinal side as shown in FIG. 35. Pivoting latch 612 extends from cover 604 at the front longitudinal side thereof at a location above step 608. Step 610 extends from cover 604 at the rear longitudinal side thereof opposite latch 612. Storage container 600 forms part of a stackable storage system as described above. The overall surface area defined by container 600 is about one quarter that of storage module 410′.

With reference to FIG. 36B, half sized storage container 700 is shown. Container 700 includes storage base 702 and cover 704 pivotably secured on storage base 700. Step 708 extends downwardly from the lower surface of base 702 along the right lateral side thereof. A similar step extends downwardly from the left lateral side as shown in FIG. 35. Pivoting latches 712 extend from cover 704 at the right and left lateral sides thereof at locations above steps 708. Storage container 700 forms part of a stackable storage system as described above. The overall surface area defined by half-sized storage container 700 is about twice that of quarter-sized container 600, and half that of drawer storage module 410′.

With reference to FIG. 35, work platform 500 may be secured on an arrangement of two quarter-sized containers 600 and one half-sized container 700. The longitudinal front and rear sides of containers 600 extend perpendicularly to the longitudinal front and rear sides of container 700 such that each latch 612 of one container 600 extends along the same direction and in the same plane as one latch 712 of container 700. Therefore, one of latches 612 and 712 is disposed over each one of front and rear steps 513(a), 513(b), 513(a)′ and 513(b)′ to secure work platform 500 on quarter sized containers 600 and half sized container 700.

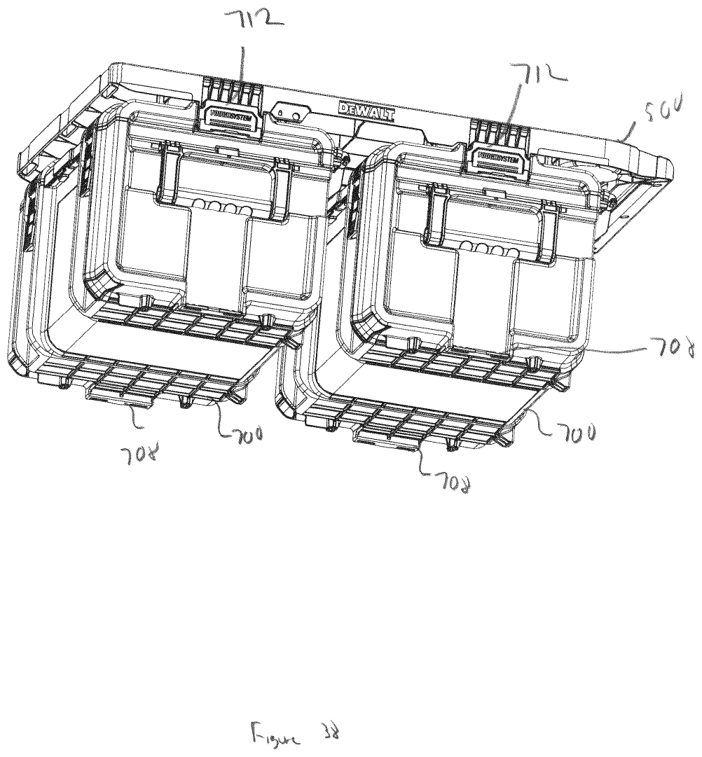

With reference to FIG. 37, work platform 500 is secured on an arrangement of four quarter-sized containers 600. Containers 600 are arranged in two pairs, with each pair having their longitudinal sides and thus latches 612 extending along the same direction and in the same plane. Therefore, the overall arrangement of containers 600 is such that there are two latches extending outwardly from the front and rear jointly formed longitudinal sides. Therefore, one latch 612 is disposed over each one of front and rear steps 513(a), 513(b), 513(a)′ and 513(b)′ to secure work platform 500 on quarter sized containers 600.

With reference to FIG. 38, work platform 500 is secured on an arrangement of two half-sized containers 700. Containers 700 are arranged such that the longitudinal sides extend along each other to create a combination with two latches 712 extending along the same direction and in the same plane on each of the jointly formed left and right lateral sides. Therefore, one latch 712 is disposed in each one of front and rear steps 513(a), 513(b), 513(a)′ and 513(b)′ to secure work platform 500 on half-sized containers 700.

While the invention has been described by way of exemplary embodiments, it is understood that the words which have been used herein are words of description, rather than words of limitation. Changes may be made within the purview of the appended claims, without departing from the scope and spirit of the invention in its broader aspects.

1. A work platform:
a work surface;
a peripheral rim extending downwardly from said work surface;
at least one step formed on said peripheral rim;
at least one through hole formed on said peripheral rim; wherein,
said work platform may be disposed on an upper surface of a storage container, the storage container having a locking opening and at least one latch disposable over said at least one step to secure said platform on the container with the locking opening aligned with said at least one through hole.

2. The work platform recited in claim 1, said rim extending downwardly from said work surface on at least first and second opposite sides thereof, said at least one step comprising a first step formed on said first opposite side and a second step formed on said second opposite side, wherein the at least one latch of the storage container includes at least two latches, with each of the latches disposable over one of said first and second steps.

3. The work platform recited in claim 2, said at least one through hole comprising a first through hole formed on said peripheral rim and a second through hole formed on said second step, wherein, said work platform may be disposed on the storage container in a first orientation in which said first through hole is aligned with the locking opening or in a second orientation in which said second through hole is aligned with the locking opening.

4. The work platform recited in claim 1, said rim extending downwardly from said work surface on at least first and second opposite sides thereof, said at least one step comprising a first step formed on said first opposite side and a second step formed on said second opposite side, said at least one through hole comprising a first through hole formed on said first opposite side and a second through hole formed on said second opposite side, wherein, said work platform may be disposed on the storage container in a first orientation in which said first through hole is aligned with the locking opening or in a second orientation in which said second through hole is aligned with the locking opening.

5. A system comprising a storage container and a work platform, said storage container comprising at least one latch and at least one locking opening;
said work platform a work surface, a peripheral rim extending downwardly from said work surface, and at least one step formed on said peripheral rim, and at least one through hole formed on said peripheral rim; wherein,
said work platform may be disposed on an upper surface of said storage container with said at least one latch disposable over said at least one step to secure said platform on the container with said at least one locking opening aligned with said at least one through hole.

6. The system recited in claim 5, said storage container comprising a lock bar, said locking opening formed in said lock bar.

7. The system recited in claim 6, said peripheral rim extending downwardly from said work surface on at least first and second opposite sides thereof, said at least one step comprising a first step formed on said first opposite side and a second step formed on said second opposite side, wherein said at least one latch of said storage container includes at least two latches, with each of said latches disposable over one of said first and second steps.

8. The system recited in claim 7, said at least one through hole comprising a first through hole formed on said peripheral rim and a second through hole formed on said peripheral rim, wherein, said work platform may be disposed on said storage container in a first orientation in which said first through hole is aligned with said locking opening or in a second orientation in which said second through hole is aligned with said locking opening.

9. The system recited in claim 6, said peripheral rim extending downwardly from said work surface on at least first and second opposite sides thereof, said at least one step comprising a first step formed on said first opposite side and a second step formed on said second opposite side, said at least one through hole comprising a first through hole formed on said first opposite side and a second through hole formed on said second opposite side, wherein, said work platform may be disposed on said storage container in a first orientation in which said first through hole is aligned with said locking opening or in a second orientation in which said second through hole is aligned with said locking opening.

10. A system comprising a storage container and a work platform, said storage container comprising an upper surface, a first latch disposed on one side of said upper surface, and a second latch disposed on an opposite side of said upper surface;
said work platform having a work surface and a peripheral rim extending downwardly from said work surface on at least first and second opposite sides thereof, a first step formed on said first opposite side and a second step formed on said second opposite side; wherein
said work platform may be disposed on said upper surface of said storage container with said first latch disposable over said first step and said second latch disposable over said second step to secure said work platform on said storage container.

11. The system recited in claim 10, said storage container comprising a lock bar, said locking opening formed in said lock bar.

12. The system recited in claim 11, wherein said peripheral rim and has at least one through hole formed therein and said storage container has at least one locking opening, wherein when said work platform is disposed on said upper surface of said storage container said at least one at least one locking opening is aligned with said at least one through hole.

13. The system recited in claim 12, wherein said peripheral rim has first and second opposite peripheral rim sides, said at least one through hole comprising a first through hole formed on said first peripheral rim opposite side and a second through hole formed on said second peripheral rim opposite side, wherein, said work platform may be disposed on said storage container in a first orientation in which said first through hole is disposed adjacent said locking opening or in a second orientation in which said second through hole is aligned with and adjacent said locking opening.

14. A system comprising:
a work platform having a work surface;
two front steps extending downwardly from said work surface at a front side thereof and
two rear side steps extending downwardly from said work surface at a rear side thereof;
at least two first storage containers, said first storage containers each having a first storage container upper surface and a first storage container latch extending upwardly from a first side of said first storage container upper surface;
at least one second storage container, said second storage container having a second storage container upper surface and a second storage container first latch and a second storage container second latch extending upwardly from opposite sides of said second storage container upper surface; wherein,
said work platform may be disposed simultaneously on all of said upper surface of said second storage container and said upper surfaces of said at least two first storage containers, with said latch of one said first storage containers disposed over one of said front side steps, with said latch of another of said first storage containers disposed over one of said rear side steps, with said second container first latch disposed over another of said front side steps and said second container second latch disposed over another of said rear side steps.

15. The system recited in claim 14, said at least two first storage containers comprising four first storage containers, wherein, alternatively said work platform may be disposed simultaneously on an upper surface of each of said four first storage containers, with said latch of one said first storage container disposed over one of said front side steps, with said latch of another said first storage container disposed over one of said rear side steps, with said latch of a third said first storage container disposed over another of said front side steps and said with said latch of a fourth said first storage container disposed over another of said rear side steps.

16. The system recited in claim 15, wherein, said upper surface of said second storage container has approximately twice the surface area of said upper surfaces of said first storage containers.

17. The system recited in claim 15, further comprising a plurality of third storage containers having a third storage container upper surface and four retainers extending upwardly from said third storage container upper surface; wherein said work platform may be disposed alternatively on said third storage container upper surface with each third storage container retainer disposed over one of said steps.

18. The system recited in claim 17, wherein, two of said retainers comprise latches extending upwardly from one side of said third storage container upper surface and two of said retainers comprise steps extending upwardly from an opposite side of said third storage container.

19. A system comprising:
a work platform having a work surface;
a first storage container having an upper surface defining a first area;
a second storage container having an upper surface defining a second area; wherein,
said work platform may be disposed and secured on a combination of four first storage containers, and said work platform alternatively may be secured and disposed on and secured on a combination of two of said first storage containers and one of said second storage containers, and said work platform alternatively may be secured and disposed on a combination of two of said second storage containers.

20. The system recited in claim 19, wherein, said second area is approximately twice the size of said first area.

21. The system recited in claim 20 further comprising a third storage container having an upper surface defining a third area, wherein said work platform alternatively may be disposed on and secured to said third storage container.

22. The system recited in claim 21 said third area being approximately twice the size as said first area.

23. A system comprising:
a work platform having a work surface;
a first storage container having an upper surface defining a first area;
a second storage container having an upper surface defining a second area; wherein,
said work platform may be disposed and secured on a combination of four first storage containers, and said work platform alternatively may be disposed and secured on said second storage container.

24. The system recited in claim 23, said second area having a size which is approximately four times the size of said first area.

25. A system comprising:
a work platform having a work surface;
a first storage container having an upper surface defining a first area;
a second storage container having an upper surface defining a second area; wherein,
said work platform may be disposed and secured on a combination of two first storage containers, and said work platform alternatively may be secured and disposed on said second storage container.

26. The system recited in claim 25, said second area having a size which is approximately two times the size of said first area.
